(19) United States
(12) Patent Application Publication
(10) Pub. No.: US 2011/0035255 A1
(43) Pub. Date: Feb. 10, 2011

(54) SYSTEMS AND METHODS FOR SUPPORTING USER GENERATED ADVERTISING TRANSACTIONS IN A VIDEO SERVICE PROVIDER ENVIRONMENT

(75) Inventors: Charles Dasher, Lawrenceville, GA (US); Robert Forsman, Sugar Hill, GA (US); Jennifer A. Schultz, Duluth, GA (US); Hugh Watkins, Canton, GA (US); Paul J. Canter, JR., Gainesville, GA (US); Christopher C. Phillips, Hartwell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/536,109

(22) Filed: Aug. 5, 2009

(51) Int. Cl. H04N 7/025; G06Q 30/00; G06Q 10/00; G06Q 50/00

(52) U.S. Cl. 705/10; 705/14.61; 705/14.69; 705/14.68; 725/32; 725/93

(57) ABSTRACT

In one embodiment, a system stores video clips which a user can select and use to create an ad video. The user can download the video clip, edit it appropriate, and then upload the ad video to the system. The user can then place the ad with a cable service provider as part of an ad campaign. The system allows the user to view available advertising opportunities with one or more video service providers, such as a cable service provider, and then define attributes of an ad campaign defining how and when to stream the ad in various programs. The ad campaign can place the ad in on-demand programs or schedule (broadcast) programs. The user can also be provided with reports indicating in part when the ad was actually streamed, allowing the user evaluate the performance of the ad campaign.

### FIELD OF THE INVENTION

This invention generally pertains to generating and managing the placement of video advertising in a video service provider environment.

### BACKGROUND OF THE INVENTION

The provision of video advertisements (“ads”) or commercials in a video service provider (“VSP”) environment is a complicated process. There are various activities that must occur in order for a viewer to see an ad in a television program.

First, the video of the ad must be generated by creative individuals knowledgeable in this area. Frequently, the video is supplemented by voice-over narratives or other sound effects. Oftentimes, the video images are overlaid or interleaved with graphics or other video images. For example, an automobile commercial may have footage of a car driving on a country highway, which is described by a voice narrative describing a car manufacturer sale promotion event, followed with images of a local car dealership and their contact information. In many instances, the same video clips are used but altered with different local car dealership contact information, thus generating a series of similar, but customized ad videos.

After the final video ad is produced, the ad may then be scheduled for showing (“placing the ad”) with a video service provider. “Ad placement” can be defined in one embodiment as the schema for schedule one or more ads in an advertising campaign. The ad can be played in local or national markets, which may involve placing the same ad with multiple video service providers (e.g., such as cable service providers in a regional area). The ad may be played at certain times of the day, in certain demographic locations, and in conjunction with certain programs. Because there are limited opportunities to place an ad with a program, there may be competing entities desiring to have their ad placed in the same program—thus, there needs to be scheduling mechanism to determine which entity's ad is placed. Prior to presenting the ad, the ad may have to be edited in time, converted into a suitable format suitable for the service provider's equipment, and stored by the appropriate video service providers and scheduled for showing as contracted. Reports are typically generated indicating details of when the ad was played.

The above description is only a cursory overview of some steps that occur in the process of placing an ad in a video service provider's system, and which illustrates some of the complexity and the various individuals potentially involved. The above prior art process can be difficult and/or very expensive for a small business to place an advertisement.

However, many of the functions necessary to place an ad have been partially automated or can be performed by individuals without special skills using low cost computers with specially adapted software. For example, creating and editing a digital video files was very difficult a few years ago, but can be now readily done using off-the-shelf consumer electronic devices. Further, producing video files in formats capable of being processed by professional video equipment used to be cost prohibitive a decade ago, but can be readily and cheaply converted to formats capable of being used by a cable service provider. However, as of yet, an integrated solution to facilitate generation and placement of ads has not yet been developed.

### BRIEF SUMMARY OF THE INVENTION

In one embodiment, a system and method is presented that allows individuals to generate video clips which can be made available for use by those desiring to place ads in a service provider. A system allows the video clips to be uploaded from individuals creating the video clip, where the video clip then can be viewed, and then selected by a potential ad purchaser. The ad purchaser may download the video clip, customize the video clip to form an ad, and then upload it to the system for placement in a video service provider. In another embodiment, the system provides the ad purchaser with the ability to place the ad with one or more video service providers, including indicating parameters defining the ad campaign, including where and when the ad should be shown. The ad purchaser may receive reports of when it was actually streamed to viewers and can be billed accordingly.

### BRIEF DESCRIPTION OF THE SEVERAL VIEWS OF THE DRAWING(S)

FIG. 1 illustrates one embodiment of steps involved with an Ad Originator uploading a video clip and an Ad Purchaser obtaining the video clip.

FIG. 2 illustrates one embodiment of the system architecture for the Ad Broker interacting with other elements.

FIG. 3 illustrates one embodiment of profiles associated with an Ad Purchaser.

FIG. 4 illustrates one embodiment of mapping an ad to an avail.

FIG. 5 illustrates another embodiment of mapping an ad to an avail.

FIG. 6 illustrates one embodiment of internal architecture of the Ad Broker system.

FIG. 7 illustrates one embodiment of the physical architecture of the Ad Broker system.

FIG. 8 illustrates one embodiment of a screen image illustrating various ads to an Ad Purchaser.

FIGS. 9a-9b illustrate one embodiment of presenting available avails to an Ad Purchaser.

FIG. 10 illustrates one embodiment of interacting with an Ad Purchaser for mapping an ad to on-demand programs.

FIG. 11 illustrates one embodiment of an ad campaign report.

FIG. 12 illustrates another embodiment of the system architecture for the Ad Broker.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer-readable program products. It should be understood that each block of the block diagrams and flowchart illustrations, respectively, may be implemented in part by computer-readable program instructions, e.g., as logical steps or operations executing on a processor in a computing system. These computer-readable program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

Accordingly, blocks of the block diagrams and flowchart illustrations support various combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

The term “Ad Purchaser” as used herein refers to an individual or a computer system operated by said individual that interacts with the system (“Ad Broker”) for selecting an ad and/or placing the ad in a video service provider. The Ad Purchaser can refer to the individual obtaining rights, permission, or ownership to use a video clip in an advertisement, regardless of how those rights are obtained, or what the scope of those rights are. The Ad Purchaser can also refer to the individual obtaining the scheduled time slots in a video service provider for showing the ad. In some embodiments, reference to “Ad Purchaser” can refer to an individual or entity that can be one, or the other, or both. The Ad Purchaser can also be an entity that is providing a service to another, and hence is not the ultimate purchaser of the ad. The term “purchaser” is used broadly, and does not imply any required form of how the service obtained, what capabilities are invoked, or how payment is made.

The term “placing an ad” refers to the various steps involved in having an ad incorporated into the viewing experience of a program to an audience. Typically, the audience is a subscriber of a video service provider, such as a cable service provider. A “video service provider” (“VSP”) typically is directly or indirectly is involved with the Ad Purchaser, since the Ad Purchaser in some embodiment is agreeing to place ads with a VSP. Although a cable service provider (“CSP”) is used to illustrate the principles of the present invention, a CSP is but one type of a VSP, and other types of VSPs that provide on-demand movies or broadcast television program are encompassed by the term “video service provider”, including fixed wireless video service providers, IPTV providers, cellular telephone providers providing video, satellite program providers, etc. No particular technology is (such as coaxial cable, HFC, or other forms are implied when using the term “cable service provider.”

The term “Ad Originator” refers to an individual or a computer system operated by said individual that generates a video clip which may form the basis of an ad. Because such individuals are typically relying on their creative talent in producing such video clips, they are sometime referred to in a shorthand lexicon as the “talent” or “talented individuals.” The “Video Clip” typically refers to the video produced by the Ad Originator which is manifested in the form of a digital video file, but which has not yet been modified to become the Ad Video itself. Once modified, the video is referred to herein generally as the “Ad Video” or “Ad Asset.” Typically, once the Ad Video is modified to be compatible with a VSP and stored in the VSP, it is referenced herein as an Ad Asset. The Ad Asset typically complies with industry standards for providing information in a certain form, which includes information about the contents (e.g., metadata).

As will be evident, in many cases the terms “Ad Purchaser” or “Ad Originator” may refer to a computer system or the person operating the computer system. This distinction, if any, should be clear from the context.

An “Ad Campaign” refers to the information required to define the necessary attributes of an advertising promotion. For example, an Ad Purchaser will have to define when the ad promotion begins and ends, which ads are to be shown, and in conjunction with which VSPs, etc. The exact scope of the data required to form an Ad Campaign can vary from embodiment to embodiment. It is often the case that an Ad Purchaser may be providing a service to a number of its clients, such that the Ad Purchaser has numerous campaigns occurring. Typically, these are given a name for convenience. Thus, an Ad Purchaser may have a “blue jean ad campaign” and a “sports car ad campaign.” It is immaterial whether the Ad Purchaser actually markets or manufactures blue jeans or sports cars.

### Service Description

The service description indicates what features are possible of being performed by one or more embodiments of the disclosed system. Although the service description should be independent of how the implementation of the features occur, some description of the components used is provided to facilitate explanation. Because many of the features are typically embodied in a system comprising a server, the term “Ad Broker Server” is synonymous with the system providing the features. However, it should be realized that other components or implementations are possible, other than using a “server.”

### Service Overview

The set of capabilities provided to the Ad Purchaser can be divided into two main service phases: (1) Ad Generation and (2) Ad Placement. Ad Generation refers to the steps associated with creating an Ad Video or Ad Asset that is ready to be incorporated into an Ad Campaign. These steps typically include generating the Video Clip, posting it at a central repository (e.g., the Ad Broker Server hosting the “Ad Broker Web Site”) where potential Ad Purchasers can view the Video Clip, followed by the Ad Purchaser selecting and obtaining rights to use the Video Clip. The Ad Purchasers then can download the Video Clip, customize it, and then upload it back with its final content to the Ad Broker Web Site. Once the video clip contents are in final form, it is referred to as the Ad Video. It may be further transformed into a format that makes it ready to load into a VSP. If so, then it is referred to as an Ad Asset. However, if the Ad Video is not transformed, it can be relatively easily formatted.

Once the Ad Asset is created, the next service phase is encountered: Ad Placement. Ad Placement refers to the various steps involved in the Ad Broker Web Site interacting with the Ad Purchaser as well as with various systems of one or more VSPs in order to create, modify, and execute the Ad Campaign (e.g., place the ad). This involves defining which Ad Assets are stored in, or provided to, various VSPs for playing the ad to their subscribers or users. The Ad Placement phase also includes aspects that occur during or after execution of the Ad Campaign, such as reporting to the Ad Purchaser details of when the Ads were shown during the Ad Campaign. Thus, the Ad Placement Phase broadly covers any of the aspects of the Ad Broker for placing an ad. However, Ad Placement presumes that the Ad Purchaser has an Ad Video or Ad Asset that is ready to be placed. It is not necessary that the Ad Asset involved in the Ad Placement phase was a product of the Ad Generation phase. In some embodiments the Ad Purchaser can obtain the Ad Asset through other sources.

### Ad Generation

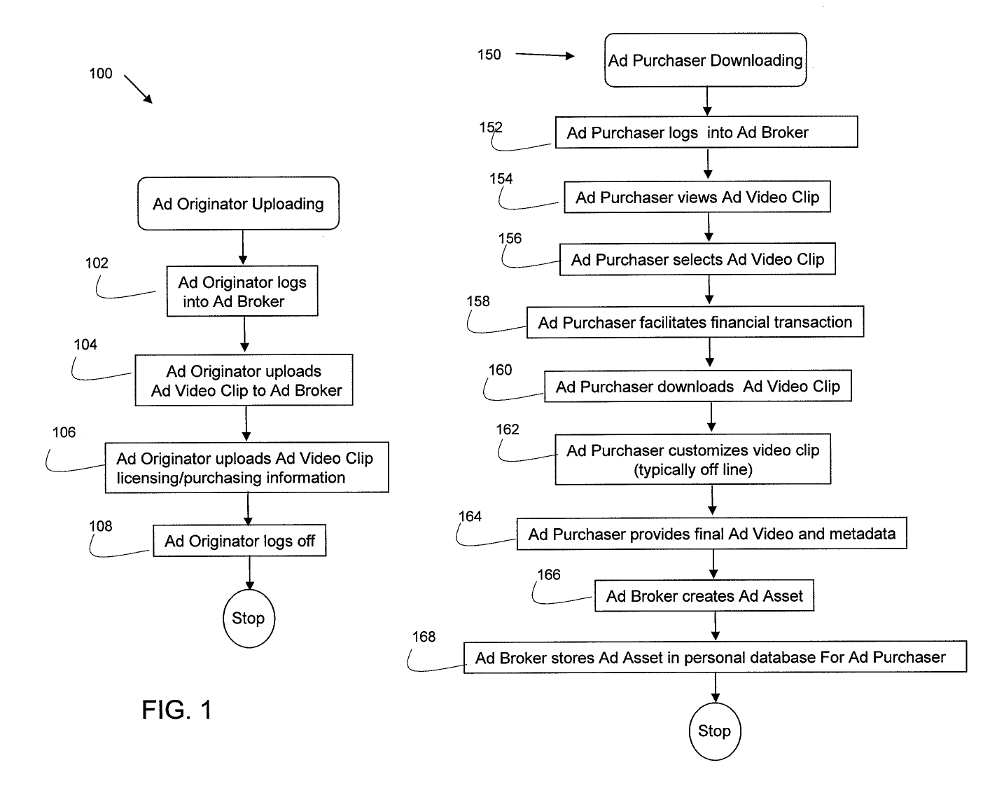

Ad Generation typically involves two separate, but related processes. First, an Ad Originator must create and upload a video clip into the Ad Broker for public viewing. Second, after the video clip is uploaded, an Ad Purchaser may access the Ad Broker and obtain the video clip in order to customize the video clip to generate the Ad Video, and post it back onto the Ad Broker. The steps for performing are shown in FIG. 1.

In FIG. 1, process 100 illustrates one embodiment of the Ad Originator Uploading a video clip. This begins at step 102 with the Ad Originator using a computer to log into the Ad Broker Server. The next step 104 involves the Ad Originator uploading one or more video clips to the Ad Broker. These were created previously off line by the Ad Originator, and may involve use of computing systems, video processing equipment, video editors, etc. The format of the uploaded video may be in a variety of formats. In one embodiment, the video clip is a digital MPEG-2 formatted video data file. In another embodiment, the video clip is in an Internet viewable form. In addition, as illustrated in step 106, the Ad Originator may provide other information about the clip, such as the Ad Originator, licensing terms, payment terms, etc. When all the information is uploaded, then in step 108 the Ad Originator logs off. The process of uploading a video clip onto the Ad Broker by the Ad Originator is completed.

The Ad Originator can upload the video in a variety of formats, including .mpg formats, Quicktime®, Windows® media video, .avi, MPEG2, MPEG 4, 3GP, H.264 and other formats.

Once the video clip is uploaded, then it can be viewed by potential Ad Purchasers. This is shown in the Ad Originator Uploading process 150 of FIG. 1. The process begins in step 152 when the Ad purchasers logs into the Ad Broker, and provide identification information. In this manner, the Ad Broker knows who the Ad Purchaser is. Because the Ad Broker may also track compensation and manage the rights for using the video clip, the Ad Broker typically maintains identification of each user—of both the Ad Originator and Ad Purchaser. However, in various embodiments any potential Ad Purchaser can view video clips without having to log into the Ad Broker. The Ad Broker typically provides various search tools, which can include search by subject, name of the Ad Originator, or video clip identifier. Typically, a series of thumbnail images of the videos are shown to the Ad Purchaser. In this manner, the Ad Purchaser can search for ads of a particular subject matter (e.g., cars), ads originating from a particular Ad Originator (e.g., “John Doe Video Production Company”), or a particular numerical video clip identifier (typically, provided to the Ad Purchaser separately by the Ad Originator).

In step 154 the Ad Purchaser may select a thumbnail or file identifier, and view the contents of the video. Typically, when viewing the video clip, the viewer is viewing a reduced definition version of the video. If the video clip is acceptable to the Ad Purchasers, in step 156 the Ad Purchaser then selects the video clip for “purchase.” Although illustrated or described herein as the Ad Purchaser “purchasing” the video, the term “purchasing” encompasses either assignment of rights or obtaining a license to the video. Thus, it is possible that the Ad Purchaser does not formally purchase the video involving a complete assignment of all rights, but merely licenses the video. Various forms of licenses are possible, including an limited time exclusive license, or otherwise limited in rights. It is possible that different video clips may have different terms—e.g., a price for a limited license, another price for an exclusive license, yet another price for purchase of all rights, etc. The Ad Broker presents the terms of the purchase to the Ad Purchaser, which after agreeing to the terms, allows the Ad Purchaser to download the full resolution video and/or data evidencing authorization to use the video clip. In some embodiments, the Ad Broker may also complete the financial transaction by debiting an account, charging a charge account, or otherwise arranging a transfer of funds between the Ad Purchaser and the Ad Originator.

Once the Ad Purchaser has purchased the video clip (or otherwise obtained exclusive rights), the Ad Broker will label the video clip as being associated with the Ad Purchaser. In some embodiment, on the Ad Purchaser is then provided rights with viewing the video clip. This can be accomplished in various ways. In one embodiment, the personal library is a file directory comprising the purchased files where the Ad Purchaser has access to the contents. In another embodiment, the video clip is linked with rights to view and use the video clip, which can be limited to the Ad Purchaser. Assuming that the Ad Purchaser has purchased the video, the ad is no longer viewable by other users. Thus, in one embodiment the ad is removed from the public directory to a private directory associated with the Ad Purchaser (or other mechanisms to effect a similar result). The Ad Originator does not explicitly authorize this action, but is initiated by the Ad Purchaser when purchasing the ad.

At this point, the Ad Purchaser may log off from the Ad Broker, and return by logging back onto the Ad Broker Server at a subsequent time. It is presumed that during this time the Ad Purchaser will modify the video clip to convert it into a suitable Ad Video. Specifically, the video clip may be edited, dubbed over with additional sounds or voices, incorporate graphic overlays, etc. In most cases this is required because a “raw” video clip is unsuitable as an advertisement video by itself, and must be customized for the particular Ad Purchaser. However, it is possible that the Ad Originator may post a complete Ad Video which does not require any further editing. In such instances, the Ad Purchaser may merely obtain the rights for using the Ad Video and can then proceed to placing the ad. In other embodiments, the Ad Originator may produce a generic video clip that can be easily customized for various business franchise locations by merely by adding the franchise location specific information to the ad video.

The Ad Purchaser may contract with a third party video editor, or use well known video editing tools to further edit the video clip in step 162. Whatever method is used to accomplish this step, the Ad Purchaser then provides in step 164 the Ad Video and associated metadata to the Ad Broker. The metadata may be provided by the user in a separate file. Such metadata typically conforms to industry standards, such as CableLabs® Advertising Distribution 2.0 Specification (Metadata 2.0 Specifications), MD-SP-ADVS2.0-I01-070105, dated Jan. 5, 2007, the contents of which is incorporated by reference. This meta data may include fields, for example: indicating an Asset Identifier, a start/end time for using the asset, a Provider Identifier, a description, copy privileges, format indicators for HD or SD, etc. Alternately, an application program in the Ad Broker can prompt the Ad Purchaser for various types of metadata and generate the metadata file in an industry conforming format. In other embodiments, the Ad Purchaser may create a series of ads corresponding to various franchise locations. For example, in a metropolitan area having multiple locations of a franchise (e.g., a pizza fast food chain), multiple versions of the same ad can be created and uploaded with different local address information. Thus, the Ad Purchaser may purchase one instance of a video clip, and then customize it in various ways to generate a number of distinct (but similar) ad videos.

The Ad Broker includes processing routines to convert the Ad Video into an encoding format compatible with the VSP's systems in step 166 if necessary. In this embodiment, the video is converted from, for example, an Internet based video encoding format such as FLASH into format compatible with a cable service provider, such as an MPEG-2 format. In other embodiments, the format conversion process can take place as an initial step of the placement process. This can be done by the processor in the Ad Broker system, or there may be special purpose transcoder in the Ad Broker for performing this function. Once the ad video has been “purchased”, the Ad Broker system creates a logical “personal library” (e.g., a restricted directory space) if not already defined for the Ad Purchaser, where the Ad Asset is placed. As noted above, this can be accomplished in various ways, such as managing a user's rights to view certain video clips. It is anticipated that Ad Purchasers will maintain a selection of Ad Assets that represent their past or proposed ads. Thus, when an Ad Purchaser creates the various ad videos that are customized for various locations, each of these ads can be uploaded into the personal library of the Ad Purchaser in the Ad Broker system.

It is possible that Ad Purchasers may download a previous uploaded Ad Asset, modify it locally, and then upload it back into the Ad Broker. Thus, an Ad Purchaser may obtain rights to a video clip, download it, locally edit it, and then upload it to the Ad Broker for placement in a VSP. Subsequently, the Ad Purchaser may download that Ad and further modify the Ad Asset (whether to correct information or form a new ad for a new ad campaign) and then upload it back into the Ad Broker.

### Ad Generation Architecture

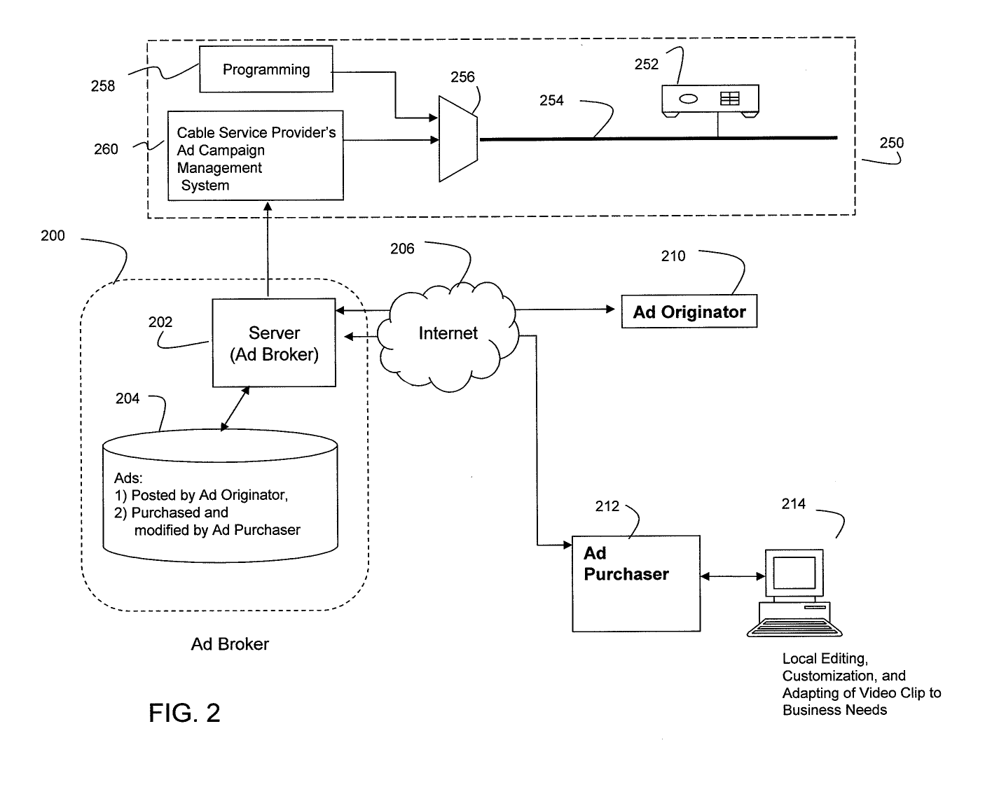

FIG. 2 illustrates one architecture configuration for the above process. In FIG. 2, the Ad Broker 200 is depicted in one embodiment as a server 202 hosting a web site that communicates with a data store 204, which stores the ads in their various forms. The server 202 is accessed by the Ad Originator 210, which represents a computer used to upload the raw ad video clip via the Internet 206 according to procedures well known in the art. Once the video clip is received by the server 202, the ad is stored in the data store 204 and available for subsequent viewing by any individual allowed access by the Ad Broker.

The Ad purchaser 212 (the icon in the figure can also representing a computer operated by the Ad Purchaser) is able to also access the Internet 206 and is able to view the various Ads which are available for licensing or purchasing. Once the Ad Purchaser 212 commits in whatever form is indicated to pay associated fees, the video is downloaded, where the Ad Purchase may use a separate local computer 214 and available editing software to modify the video clip as desired. Once the ad video is completed, the Ad Purchaser 212 logs back onto the server 202, and uploads the finished ad video to the server. The ad video is linked with limited access and viewing rights and is typically only available for viewing by the Ad Purchaser. The server may also interact with the Ad Purchaser via graphical user information to collect various information about the Ad Video, including various fields that may be used to incorporate the metadata. Typically, certain values of fields in metadata that are created by the Ad Originator are changed by the Ad Purchaser. For example, the title of the contents may be changed by the Ad Purchaser to more closely reflect the purpose of the ad or the name of the campaign given by the Ad Purchaser. Other values of the metadata may be defined by the server by processing the ad asset or by administrative personal interacting with the Ad Broker. For example, the metadata includes various fields indicating the formatting values, which may be determined by the Ad Broker without input from the Ad Purchaser.

In one embodiment, the Ad Broker ensures that the ad is formatted in a “package” with metadata conforms to an industry standard, such as those published by CableLabs®. A package is a video asset, such as a advertisement, which comprises a certain structure with certain information about the video, called metadata. Examples of metadata that are included along with a video clip in various embodiments include: (1) a unique identifier for the provider of the video clip; (2) an identifier for the product offering; (3) a string identifying the name of the video clip; (4) a human-readable string describing the video clip; (5) a string representing the date on which the video clip was created; (6) audio types available for this video clip; (7) the screen format (e.g., Standard, Widescreen, and Letterbox) for the video clip; (8) the available languages for the video clip; (9) an indicator of whether the video clip is copyright protected; and (10) the file size of the video clip. Some of these fields may be determined by information provided by the Ad Originator (e.g., description of the video clip, date created) whereas others may be generated by the Ad Broker system when it generates a Ad Asset compatible with the video service provider (e.g., screen format, file size, etc.).

The Ad Broker may also transcode the video clip (both the video and audio portions) uploaded by the Ad Originator into a suitable format, such as MPEG 2 SD, MPEG 2 HD, H.263 or any other format used by the video service provider. Typically, for cable service providers, an MPEG 2 or MPEG 4 format is used.

### Ad Placement

As noted previously, Ad Placement refers to the series of steps and elements required to define and execute an ad campaign for an Ad Asset stored in the Ad Broker. An ad campaign comprises information defining how and where a given ad is to be provided to subscribers in a VSP system, such as in a cable service provider. Ad Placement can be described in terms of various capabilities performed by the Ad Broker, some of which may involve interaction between the Ad Broker and the Ad Purchaser and other capabilities which involve interaction between the Ad Broker and the VSP. The Ad Broker interacts with an Ad Campaign Manager (“ACM”), which is a system(s) in the VSP that manages placement of ads in a VSP. However, as it will be seen, the ACM does not provide capabilities adapted to limit access and control to a specific Ad Purchaser, but rather provides access and control to a VSP system administrator, which is a different and broader set of capabilities.

Ad Placement is typically different when:
1) placing an ad in conjunction with a scheduled set of programming (such as scheduling television programs for a source of programming), and
2) placing an ad in conjunction with on-demand programming, which by definition is not scheduled for viewing.
   In many instances, scheduled programming is broadcasted to a wide audience, whereas on-demand is transmitted to a single requesting viewer, which can occur at any time. In the former case, the ad can be scheduled, and it is determinative that the ad will be presented. In the latter case, the ad can be streamed, but it is not determinative that the program will be requested, and hence it is not determinative that the ad will be played. These distinctions typically manifest themselves mainly when defining the mapping of an ad with one or more programs.

Ad Campaign States

To facilitate illustration of embodiments of the invention, an Ad Campaign can be viewed as having various states. The “draft state” refers to the creation of an ad campaign prior to when values are approved by the Ad Purchaser. This is akin to a “pending” state, where values can be altered without impacting the various VSPs systems. This state includes processing input from the Ad Purchaser in order to complete the set of data defining an ad campaign. Once completed and approved, the Ad Campaign is submitted for processing by the Ad Broker for placement. If unaccepted, the Ad Campaign is in a “rejected state” or “inactive state” and will remain there until the conditions causing the rejection are corrected and the data is resubmitted. If accepted, the Ad Campaign is in an “approved state” meaning the campaign data has been accepted and is waiting for ads to be integrated with the programs. Once the first ad is integrated, the Ad Campaign is an “executing state.” Typically, the Ad Campaign will migrate from the approved state to the executing state automatically, by the passage of time. Once the executing state is entered, it may stay in that state for a number of days or weeks, until the campaign is completed. Once completed, the Ad Campaign is in a “completed state.” The passage from the executing state to the completed state typically occurs automatically. Typically, administration personnel can manually instruct the Ad Broker to override a present state of an Ad Campaign. For example, administration personnel can move an “executing state” to an “inactive” state. Doing so, may result in communication from the Ad Broker to the VSP, and cause the ads to be not played as expected. This means that any ad spots will be replaced by the VSP with other ad spots when they are processed. As used herein, the Ad Campaign Placement Phase encompasses all of the above states.

Creating an Account and Profile Associated with an Ad Purchaser

Prior to the Ad Purchaser defining the Ad Campaign or interacting with the Ad Broker server for planning an Ad Campaign, the Ad Purchaser must establish an account with the Ad Broker. Typically, an account established for Ad Generation can be used to accomplish the necessary purposes of an account for Ad Placement. The term “account” for purposes of Ad Placement refers to establishment of a profile and various related information. The term “account” does not necessary imply any particular billing or payment arrangement, although typically billing and/or payment is often associated with the Ad Purchaser's account in conjunction with Ad Placement.

The Ad Purchaser provides a user-identifier and password when the Ad Purchaser logs onto the Ad Broker server during the Ad Placement phase, so that the Ad Broker server is aware of the Ad Purchaser. The password authenticates the user as the Ad Purchaser. The Ad Purchaser is typically afforded the capability of altering the password, and may also add and define various sub-users which have limited capabilities. Thus, users associated with the Ad Purchaser account may have different capabilities or privileges, such as read only, limited administrative capabilities such as halting executing of the Ad Campaign, etc. In the embodiment herein, it is presumed the Ad Purchaser logged onto the Ad Broker server has all the capabilities that can be afforded to a user acting as an Ad Purchaser.

### Ad Purchaser Profiles

The identification of the Ad Purchaser is used by the Ad Broker Server to filter or otherwise limit information presented to the Ad Purchaser or that can be updated by the Ad Purchaser. This is accomplished by using a “Profile” which is associated with an account and maintains information specific to the Ad Purchaser. For example, ads maintained by the Ad Broker are associated with a particular Ad Purchaser. The Ad Broker may maintain a schedule for each Ad Purchaser as to when their particular ad is being scheduled. The Ad Broker only presents information to an Ad Purchaser that is associated with that Ad Purchaser's ad and screens or filters information of other users. Thus, an Ad Purchaser cannot view particular details of other ad purchasers' schedules.

The Ad Purchaser can also establish a profile which can be used as to filter information available to an Ad Purchaser in order to facilitate viewing of information. Multiple profiles can be created for a single account. In one embodiment, the profile acts as a predefined limit on queries for information. The Ad Purchaser may define this to facilitate information presentation and interaction with the system. For example, the Ad Broker may allow placement of ads over a number of VSPs over numerous markets, and therefore encompass a number of service providers, multiple sites per service providers, and various programming per site. Thus, the amount of potential information presented to an Ad Purchaser could be overwhelming, particularly if the Ad Purchaser is not sophisticated. The application of a profile to limit information presented to the Ad Purchaser can benefit various type of Ad Purchaser. For example, if the Ad Purchaser is a local merchant operating in a single metropolitan area, then there is no value in presenting information regarding ad placement opportunities in other regions. Similarly, if the Ad Purchaser is merchant operating in numerous locations, they typically will limit their ad planning to certain programming types in those markets. For example, the Ad Purchaser may only be selecting ads associated with a broadcast television program at a limited time window for certain content providers.

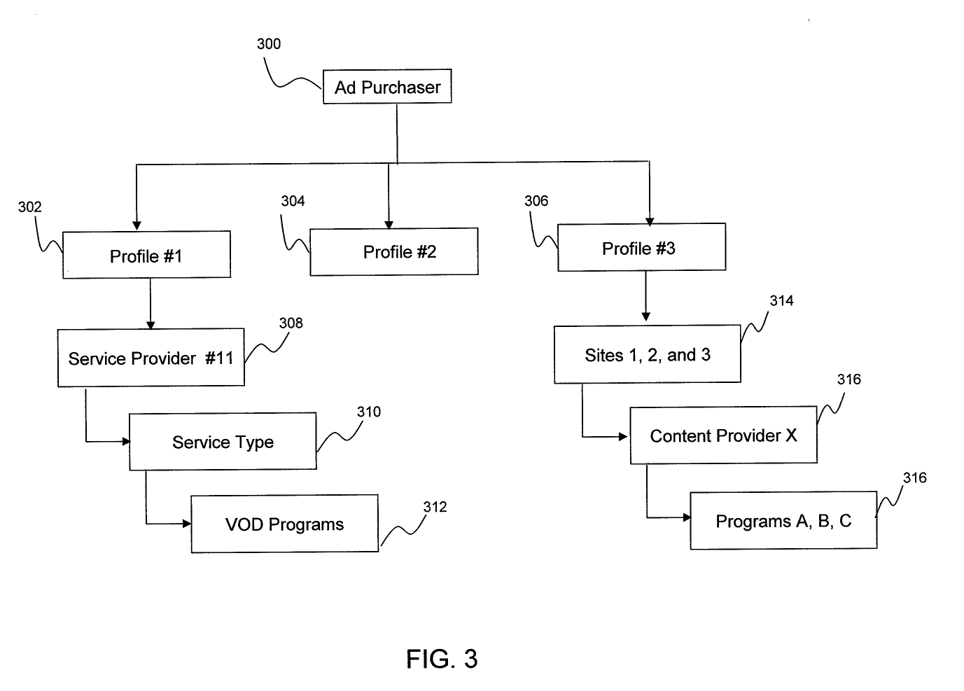

One logical representation of the hierarchy of a profile is shown in FIG. 3. In FIG. 3, the Ad Purchaser 300, which is identified at login, can select from three different profiles. In Profile #1 302, the information is predefined on the basis of a specified service provider—in this case Service Provider #1. This entity may operate in various markets, or only in one market. Thus, if a Ad Purchaser typically only places ads with a certain VSP 308 (e.g., the local cable company), then only information regarding that certain VSP is presented to the Ad Purchaser. Further, if the Ad Purchaser only advertises for a particular Service Type 310 (e.g., on-demand programming), the Ad Purchaser may then limit it to certain types of video on-demand (“VOD”) programming 312 (such as “G” or “PG” rated movies). An unrestricted profile, Profile #2 304, is shown for sake of completeness. Because this is not qualified in any way, any qualifying information requested by the Ad Purchaser is presented. The Ad Purchaser may input requests for information that are limited, to achieve a desired result. Finally, another profile, Profile #3 306 is illustrated where information is qualified based on site locations, which in this case is Sites 1, 2, and 3 314. These could correspond to, for example, cable systems located in three areas that are in a common geographical area (e.g., a main city and surrounding suburbs). The information is further qualified based on a specified content provider, e.g., Content Provider X (which could be a local broadcasting affiliate). Finally, the Ad Purchaser may only be interested in certain programs, namely Programs A, B, and C (which could correspond to morning, noon, and evening news programs).

These profiles are optional and facilitate interaction with Ad Purchasers. This does facilitate a single entity acting as an Ad Purchaser to provide advertising services for different clients advertising in different markets. Alternatively, if no profile is established (or the profile has no qualifications such as shown in Profile #2 304), the Ad Purchaser may be able to narrow information request by adding the appropriate qualifiers with each request.

As part of the profile, the Ad Purchaser may also provide various contact information, which provides information such as name of an individual, company name, telephone number, cell phone number, email address, etc. that can be used by the Ad Broker to issue automatic notifications or inform personnel operating the Ad Broker whom to contact if there are issues requiring human intervention. These are used by the event notification feature. The profile may also define how and when reporting occurs.

### Ad Planning—Reviewing Data

In order for the Ad Purchaser to be able to adequately plan to purchase ad time in a service provider's system, the Ad Broker system provides various high level capabilities to provide certain information to the Ad Purchaser that aids in the ad placement decision. The Ad Broker provides the Ad Purchaser with various capabilities allowing querying and retrieval of specific planning type information. The information is accessed in a “read only” form, and may be processed or limited based the identify of the Ad Purchaser using the aforementioned profiles.

Various types of information can be viewed by the Ad Purchaser, including the following type of information:
a. Service Providers—a service provider a the VSP potentially capable of streaming the ad over their network or to their users. In many instances, this is the service provider from which ad time is purchased by the Ad Purchaser. In one embodiment, the service provider can be a cable service provider and can identified by its business name, e.g., Cable Co. XYZ.
b. Sites—a site can identify a geographical serving area of the VSP or a single system in a geographical service area. For example, Cable Company XYY may have sites in Chicago, Miami, and Seattle. Alternatively, the Cable Company XYZ may have two sites (north and south) in Chicago. An Ad Purchaser may be local to a given site (e.g., Seattle), and hence would like to play their Ad only in their local (Seattle) market. Typically, this information is provided as a list of names for sites which reflect an associated city (or portion thereof) and state, or identification of some other location or area, such as a metropolitan serving area (“MSA”) or other indicator.
c. Content Providers—a content provider is a source of programming or video content. In many embodiments, these are names of programming channels, such as Food Network, CNN, Discovery Channel, etc. These are sometimes referred to a “channel” as in “the Food Network Channel.” In other embodiments, the providers can be video distributors, which are known in the industry. Typically, this information is provided as a list of abbreviation names of content providers.
d. Programs—a program is a particular video program that is streamed to a user, and are what the Ads are placed in. The program is typically originates by a Content Provider and is provided by a Service Provider. The program maybe further limited to a particular Site. Thus, if the Ad Purchaser is targeting home improvement type products, the Ad Purchaser may be seeking to place their ad with specific television programs targeted for do-it-yourself home repair in a certain location. Typically, programs are identified as a list of program names. These are frequently associated with a Content Provider.
e. Service Type—this identifies the type of services provided by the Service Provider (which can be limited based on site). For example, a Service Provider may provide real-time broadcast programs, fixed location video on-demand (e.g., VOD service by a cable company), mobile wireless streaming (e.g., to cell phone users), etc. The placement for ads may based on the service type. For example, a CSP may sell a local ad spot during an evening news program which is a service type comprising a broadcasted program to a local audience. Thus, the local ad spot may be viewed by thousands of households viewing the program. However, cable service provider may also sell an opening ad spot for a particular video on-demand program, which usually involves a single household viewing the program. This would be an “on-demand” service type.
f. Available Ad Spots—this refers to the available “inventory” of avails which indicates where one or more ads could be placed. The inventory can be qualified per the above parameters, so that an Ad Purchaser may ascertain “Are thee available ad spots in XYZ's Cable Company's markets in Seattle? . . . For the local evening news on channel 2? . . . During the month of June? . . . At the beginning of the news program?” The information as to what inventory is available merely indicates to the Ad Purchaser what space is available, and which is not. It does not indicate whose ads are presently scheduled. Thus, an Ad Purchaser cannot ascertain what ad slots are already committed to by a particular entity. This precludes one type of business from learning of a competitor's ad campaign plans.
g. On-Demand Service Profiles. For placement of ads with on-demand programs, the Ad Purchaser may desire to review information about when and what type of programs are selected by the VSP's viewers. This includes any data pertaining to on-demand viewing characteristics of a VSP that would inform selection of parameters by the Ad Purchaser governing how an ad is to be placed in an ad campaign. Thus, the Ad Broker may have access to information about VSP's on-demand service performance including the number of on-demand requests received by the VSP by time of day, day of week, program type, program rating, associated viewer demographics, etc.

The ability for the Ad Purchaser to view this information may require the Ad Purchaser to identify themselves prior to viewing the above information, and the response provided by the Ad Broker may be limited by the identify of the Ad Purchaser. Because the Ad Broker may interact with a number of VSPs, and over a large number of service providers, the information that can be viewed may be overwhelming. For example, an Ad Purchaser may define preferences that indicate certain localities, service providers, or other information that are relevant to a planned Ad Campaign. Thus, an Ad Purchaser operating a business in Atlanta may not care to even be informed about available ad spots for local news in Seattle, Portland, Des Moines, Chicago, etc. Similarly, if an Ad Purchaser desires to see available ad spots for early evening viewing on a particular cable service provider, then available ads in the early morning may be filtered out.

For ad planning purposes, some of the information accessed above is static, meaning it does not inherently change over a short time period. For example, the Sites associated with a cable service provider do not inherently change from day to day and thus there is no need to qualify it by date or time. Other information does inherently change over time (such as the programs offered on a particular channel at a given moment), and thus the user may specify qualifiers when requesting information. In some instances, these qualifiers could be alternatively indicated in their profile as default values). Specifically, the user may request programming information for a certain day, month, year, or time. Further, this information may be qualified by another information type. For example, an Ad Purchaser can request a listing for a specific time period of all programs available from a certain programming provider at a certain site. As an example, an Ad Purchaser may want to know the available television programs provided on the “Do-it-yourself” network available between 6:00 p.m. and 8:00 p.m. on Saturdays in the St Louis market between June 1 and July 1. In this case, the result is a listing of programs meeting the criteria. Some of the filters may be indicated in making the request, and some may be part of the Ad Purchaser's profile.

### Reviewing Ad Spot Inventory

Allowing an Ad Purchaser to reviewing programs, content sources, sites, etc. provides an initial basis for selecting certain boundaries of an Ad Campaign, but additional information regarding the “inventory” is required. Inventory requires to the capacity of programming to receive ads. In one embodiment, this is in the context of scheduled or broadcasted programs. In this embodiment, the programs have certain times where ads can be inserted, and if a program has “sold out” of all slots or times where ads can be shown, then there is no inventory associated with that program. Similarly, if all the ads for all programs from a content provider (e.g. CNN®) are unavailable for a time period, then there is no inventory available from that content provider. The context of whether inventory is available also depends on how the ads are sold. For example, if the available ads are locally inserted by a cable system, then “inventory” refers to the capacity of the local service provider. Thus, there can be an inventory of “local ads”. If ads are placed by a program provider for national distribution, then the capacity of the program provider (not the local service provider) then the context is of “national ads.” The Ad Broker server is able to report on available inventory in various contexts, including for one or more local or national ad inventory for various criteria (e.g., sites, times, programs, or otherwise).

Typically, the Ad Purchaser initiates queries about available inventory in the context of a particular program or set of programs (which are often called “assets”). This inventory can be made available by providing ads locally or nationally (e.g., a VSP operating a particular site may insert ads locally, while a content provider may insert ads for viewing on a national level the ads may be inserted by the content provider).

The available inventory can be presented to the Ad Purchaser using various metrics. The location where one or more advertisement can be located in an asset is referred to as an “avail.” Consequently, one metric of expressing available inventory is to identify specific avails that are available for ad insertion. Thus, an asset can have 10 avails, 5 of which are available to an Ad Purchaser. Alternatively, or in addition, the avails can be expressed as an aggregate length of time, since different time periods for an ad are possible. These metrics can be provided by the Ad Broker for a particular asset, for a series of assets over a time period, from a content provider, on an aggregate basis for a time period, etc. Generally, the indication of available inventory is bounded directly or indirectly by a time period. For example, identifying a specific scheduled asset, or set of schedule assets from a content provider during a given week, limits the time period for which the Ad Broker searches for available avail inventory.

The Ad Purchaser can also request that the Ad Broker only show which avails are available. This avoids the Ad Purchaser from viewing “sold out” inventory of assets or from content providers in the desired time period.

A typically listing of inventory for a target set of assets associated with a given site may comprise a listing which each asset comprising the following fields:
a. Name—the name of the asset, which can be a unique alphanumeric identifier,
b. Description—text describing the asset,
c. Provider ID—an unique identifier associated with the entity having rights to provide the programming—e.g., a network or content provider,
d. Product—indicates whether the asset is an on-demand type of asset, a broadcast asset, etc.,
e. Received Status—indicates whether the asset has been received by the site or whether it is scheduled to be received,
f. Start/Ending Date—indicates when the asset is to be shown or is available,
g. Forecast Month—indicates when the asset is scheduled to be available for the site,
h. Total Avails—indicates all of the ad slots, which can be expressed in a numerical value, time, or both, and
i. Available Avails—indicates the avails from the total avails which have not yet been committed, which can also be expressed in numerical values, time or both.

In another embodiment of the invention, the Ad Purchaser can review information pertaining to on-demand programming. On-demand programming is not scheduled, but typically a service provider can provide information about anticipated avails or advertising opportunities based on historical date. For example, a service provider at a given site may know that on average, a given weekend day will result in an expected number of on-demanding viewing requests, and that an expected number of advertising avails are available. The availability of expected avails can be indicated as a number of ads, an aggregate time, etc. Typically, this is provided to the user with certain qualifiers, such as for a given site, during a certain time or day, etc.

### Ad Campaign Definition Phase

Once the Ad Purchaser has enough information to determine various parameters of an Ad Campaign, the next phase can begin: the Ad Campaign Definition Phase. The Ad Campaign Definition Phase involves the Ad Purchaser providing data to the Ad Broker, which in turn may set parameters stored in the Ad Broker and interacts with various ad campaign systems in various VSPs. Thus, this phase is characterized by receiving input from the Ad Purchaser to set aspects of a particular campaign.

Ad Plans

At a high level, the Ad Purchaser typically is committing to place a number of ad slots in a particular cable system provider's system to effect a particular campaign. Typically, the Ad Purchaser is committing to purchase the service, either from the cable system provider or the Ad Broker (which may in turn have contracted with a number of cable service providers). The fee structure presented to the Ad Purchaser usually depends on various factors, such as what time of day the ads are placed (primetime or mid-afternoon), how many ad spots are purchased, the length of each ad spot, etc. These limitations are often defined by parameters either individually or that are combined in a set. Defining each parameter individually requires defining various parameters for each variable and can be time consuming. As an alternative, a set of parameter values corresponding to an advertising “plan” can be presented by the Ad Broker to the Ad Purchaser, which facilitates marketing of the ads. The ad plan is a set of ad spots or other parameters that are bundled and sold to an Ad Purchaser as a single unit. For example, the “basic” advertising campaign plan offered by a cable service provider may define 5 minutes comprising ten thirty second ad spots during the hours of 9:00 a.m. to 5:00 p.m. over a one week period during a defined week. Other advertising levels can be defined comprising a different set of parameters (e.g., a greater fee charged for a greater number of ad spots). Obviously, numerous variations are possible as to what plans are offered to an Ad Purchaser.

It is possible for the Ad Purchaser to select a particular Ad Plan and have the Ad Broker enforce these parameters for a particular Ad Purchaser when creating an Ad Campaign. In one embodiment, the Ad Broker prompts the Ad Purchaser for a particular advertising plan level which has associated with a set of parameters. In another embodiment, the Ad Purchaser has separately contracted with a business entity operating the Ad Broker for a particular advertising plan level and administrative personnel defines the advertising plan level in the Ad Purchaser's profile. It is possible that the Ad Broker may further have a variety of plan levels, some of which only apply to certain VSPs. In any case, the Ad Broker uses the advertising plan level to define a set of parameters which guides the allocation of resources for that Ad Purchaser when creating a campaign. For example, if the Ad Purchaser is linked with the above “basic” advertising plan that is limited to 10 ad spots, the Ad Broker will limit a campaign to no more than 10 ad spots. In one embodiment, the Ad Broker will not allow the Ad Purchaser to select an 11 ad spot. Similarly, other parameters are checked and enforced.

Some of the parameters associated with an Ad Campaign that can be enforced by the Ad Broker include:
a. Maximum number of appearances of Ad in Program—this indicated the maximum number of times a particular ad can be placed in the same ad. Typically, this is a numerical value between 1 and 25, or “any.”
b. Avail Position Preference—this indicates what type of avail is preferred for placement of an Ad. These can be “first position”, “last position”, “second position”, or “any.” Typically, the location of an ad influences the price of the purchased ad spot. In some embodiments, this value may be fixed (and not presented as an option to the Ad Purchaser) based on a prearranged contract. For example, an Ad Purchasers may have contracted for purchasing initial avails during prime time. In such cases, after identifying the Ad Purchaser, the Ad Broker will only allow initial avails (which are available) to be selected by the Ad Purchaser. On the other hand, if the Ad Purchaser has purchased only “second position” avails, the Ad Purchaser will not be able to select initial avails for an ad.
c. Total Ad Time—this indicates the total number of seconds in advertising time that can be selected by the Ad Purchaser. Thus, a single 30 second commercial or two 15 minute commercials may be allowed in some embodiments.
d. Total Number of Ads—this may limit the total number of ads that can be played.
e. Hours—this may limit placing ads to certain times of the day
f. Days—this may limit placing ads to certain days of the week.
g. Various other parameters may be defined limiting aspects of the campaign.

In an alternative embodiment, the Ad Purchaser may define an Ad Campaign as they desire, and billing is based on the placement of the ads. There is no Ad Plan to select, and the Ad Purchaser is not restricted to certain parameters. Thus, the Ad Purchaser may select however many ads to play over a certain number of avails, and the fee will be calculated accordingly. Thus, based on the VSP, the Ad Broker may require certain advertisement plans to be used, or for other VSPs, the Ad Broker may allow the Ad Purchaser to select (or indicate indirectly) each parameter as they desire.

### Creating an Ad Campaign

Creating an Ad Campaign presumes the Ad Purchaser has the necessary information in order to define the various parameters that are necessary to define the Ad Campaign. In many cases, the Ad Purchaser may have used some of the aforementioned capabilities of the Ad Broker server to obtain the necessary information, but this is not required, as the information can be obtained in a variety of other ways.

Presuming that the Ad Purchaser has the necessary information, the Ad Purchaser enters basic information defining the campaign. This may include information comprising:
a. Campaign Name
b. Description
c. Start/End Date
d. Responsible Party
e. National/Local—this indicates the scope of the ad campaign.
   The above information can be prompted for entry by the Ad Broker using various techniques, including text entry boxes, pull down menus, radio buttons, etc. The Ad Broker does not always limit text entry, and typically accepts any “name” or “description” entered by the Ad Purchaser describing the campaign.

The next data entry comprises site related data. This data must match site data stored or processed by the Ad Broker, typically the user is prompted to select from a list, based on qualifier information. For example, the Ad Broker Server may prompt the Ad Purchaser for a city, state, or MSA identifier, etc., which can be used to provide a list of qualifying site identifiers. The user can then select (using a mouse, cursor, or other techniques) the appropriate site identifier.

The next data entry comprises identifying the ad asset to be used. Typically, the user can enter an ad asset identifier of an ad previously uploaded to the Ad Broker. Alternatively, the Ad Broker can view the list the ads in the Ad Purchaser's personnel library of ads and select one of them. In yet another embodiment, the Ad Purchaser can indicate the ad asset is to be defined in the future. Again, the user can select the appropriate ads to be associated with the ad campaign using a mouse, cursor, text entry box, or other technique. In one embodiment, the Ad Broker lists all the ads that are stored in associated with the Ad Purchaser, by providing a list of ads with the following fields:
a. Name—name of ad as given by Ad Purchaser when creating the ad asset.
b. Asset Id—a unique identifier assigned by the Ad Broker for identifying the ad asset.
c. Class—indicates whether the ad is only the ad video or an ad asset (e.g., an ad package conforming to an industry specification, such as that disclosed in the aforementioned CableLabs® specification). In embodiments where the Ad Broker converted the ad video into an ad asset before completing the Ad Generation phase, this information may not be indicated as it is already present. If the ad is indicated as an ad video, then further information may be require or additional processing may be required in order to generate a suitable ad asset for placement in a VSP.
d. Runtime—indicates the length of the ad.
   It is possible for the Ad Purchaser to select a particular ad and have the system display the ad asset metadata to the user. Typically, the ad metadata conforms to industry standards, such as, but not limited to, the aforementioned CableLabs® meta data specification.

Another type of data that needs to be associated with the Ad Campaign is the asset(s) (e.g., program) to be associated with the Ad Campaign. The program asset needs to be identified within certain parameters, such as a particular program (in the case of scheduled broadcast programming) or a set of programs (in the case of on-demand programming). For example, a set of broadcast programs comprising a recurring weekly comedy program during a 3 week window can be selected. Or all programs from a particular Content Provider during a 3 hour window each weekend morning between 8:30 a.m. and 11:30 a.m. during the month of December can be selected. Each program asset is preferably has at least one available avail, otherwise its inclusion is for no purpose. Alternatively, for on-demand programming, a criteria of a type of movies (e.g., PG-13) can be indicated as a criteria of the assets to be associated with the Ad Campaign. The indication of whether a campaign is for on-demand programs or broadcast programs can be indicated by the “Service Type” parameter.

Ad Campaign Review

The Ad Campaign Review phase (“Review phase”) can be viewed as an optional subset of the Ad Campaign Definition phase (“Definition” phase). The Review phase allows an Ad Purchaser to review data for a campaign, potentially edit the data, and re-save that information. This phase essentially involves editing campaign data, and can occur at different times (and is not required to occur at all). The Review phase provides tools for the Ad Purchaser to search and identify various campaigns active or schedules. In order to review a campaign, it must have been previously created, and is either scheduled to be executed or is in the process of being executed. Once the campaign has been completed, it typically is no longer for review. In some embodiments, edits to the campaign data may be limited, either by time (e.g., prior to execution of the campaign), value (e.g., dates for the beginning/ending data may not be changed), or a combination of the two. Thus, once an Ad Purchaser has committed to certain terms, the Ad Purchaser may be limited as to which values can be changed. Alternately, changing certain campaign values requires the campaign data to be re-processed before it can execute. Thus, the Ad Broker server may allow an Ad Purchaser certain flexibility of editing certain parameters, such as updating the particular ad used for a spot (e.g., reflecting that last minute edits may have been done to the ad), which could be done prior to execution of the campaign (or even done during execution of the campaign). However, the Ad Broker Server may preclude other parameters from alteration by the Ad Purchaser once the campaign has started (e.g., the Ad Broker may not allow an Ad Purchaser to alter parameters changing the times when the ads are scheduled). In such instances, the appropriate action may be to terminate a campaign. The parameters which cannot be changed during execution of the Ad Campaign may reflect contractual terms which would require negotiation with the VSP.

Some capabilities offered to the Ad Purchaser in retrieving information about established campaigns include:
a. Identify Scheduled Campaigns—this identifies all campaigns for the Ad Purchaser which have not yet started execution, but are scheduled to be started. This can be further divided into confirmed scheduled campaigns and tentative scheduled campaigns. These sub-categories reflect whether a scheduled campaign have been accepted by the system, or is in a “draft-pending” condition.
b. Identify Executing Campaigns—this identifies all campaigns for the Ad Purchaser which are in the process of executing.
c. Identify All Campaigns—this identifies the combination of the scheduled and executing campaigns.
d. Qualifiers: the above capabilities can be qualified by:
   time period—typically from the present to a specified date, but a beginning and ending date may be specified,
   for a Particular Site—this limits the campaigns shown to results of a particular site location(s),
   for a Particular Service Provider—this limits the campaigns shown to results of a particular service provider,
   for a Particular Content Provider—this limits the campaigns shown to results associated with a particular Content Provider, and
   for a Particular Service Type—this limits the campaigns for results associated with a particular Service Type.
e. Identify Completed Campaigns—this identifies campaigns which have completed execution.
   In addition, other qualifiers or combinations of the above are possible.

When the Ad Broker returns the results to the Ad Purchaser, the information is typically presented in tabular form, with each line corresponding to one campaign, and each line having the following fields:
a. Campaign Name—this is a name of the campaign as provided by the user. In addition, the Ad Broker may instead use an “Ad Campaign Identifier” which is a unique numerical identifier used by the Ad Broker to identify the campaign. However, the name provided by the Ad Purchaser is more likely to be readily recognized by the Ad Purchaser.
b. Status—this indicates the state of the ad campaign (see above).
c. Start/End Date—this indicates the beginning and ending dates of the ad campaign
d. Responsible Party—this indicates an individual associated with the Ad Purchaser that is responsible. Typically, this is the name of the Ad Purchaser, but because the Ad Purchaser may be a department of an organization, further identification of the individual involved can be conveyed in this field.
e. Sites—this indicates the number and/or names of the sites associated with the Ad Campaign.
f. Ads—this indicates the number of ads involved in the campaign.
g. Assets—this indicates the number of assets involved in the campaign.
h. National/Local—this indicates the scope of the ad campaign.
i. Service Type—this indicates whether the campaign is for on-demand or scheduled programming.
   In addition, other fields or information can be provided.

### Ad Mapping

Ad Mapping refers to the linking of an Ad to an avail of a program. In embodiment, an avail mapping can comprise data indicating an avail and an associated ad to be placed. In some embodiments, the ad is inserted into the programming asset, and the asset with ad is stored for subsequent streaming. For reference purposes herein, this is called a “static mapping”. In other embodiments, the programming may be streamed, and the avail is processed in near real time so that the ad is retrieved and inserted into the programming and interrupts the program as it is being streamed. For reference purposes herein, this is called “dynamic mapping.” Regardless of the type of mapping, there is a point in time where an Ad is associated with a given avail in a program, but the time prior to this when the mapping is known may vary. In some embodiments, the Ad Broker allows the Ad Purchaser to statically define the mapping between an ad and an avail, and in other cases, the Ad Broker may apply certain rules that determine the final mapping in the dynamic mapping case.

In the static mapping case, the programming and their avails are known in advance. Typically, this is associated with schedule broadcast programming. Further, the ads are mapped in advance, and the expected result is that the ads are played as scheduled. However, in the dynamic mapping case, the programming may not be a scheduled broadcast program. For example, video on-demand type of products offered by a cable service provider are not scheduled, but presented to viewers as requested. Thus, while a popular program (such as a recently released movie) can be expected to be requested by subscribers on a particular weekend, exactly when and how many times it will be requested is not exactly known. An Ad Purchaser may elect to purchase the initial avail for a specific on-demand program for next 50 showings of that movie, but when these placement occur cannot be exactly predicted, because they are dynamically determined when a subscriber requests that movie.

Ad Mapping occurring dynamically is based on processing various parameters maintained by the system in real-time, or near real time. Typically, this cannot be modeled in terms of a particular static schedule, because it is not known exactly when a program will be streamed. However, it can be usually predicted how many times it will be requested within a time window.

Ad Mapping occurring statically is typically based on an anticipated schedule of programming, and the exact mapping of ads with avails is typically known beforehand. The actual selection of which ads are mapped with an available avail can be done with input from the Ad Purchaser or suggested by the Ad Broker. The former instance is called “manual mapping” while the latter is called “automatic mapping.”

Manual Ad Mapping

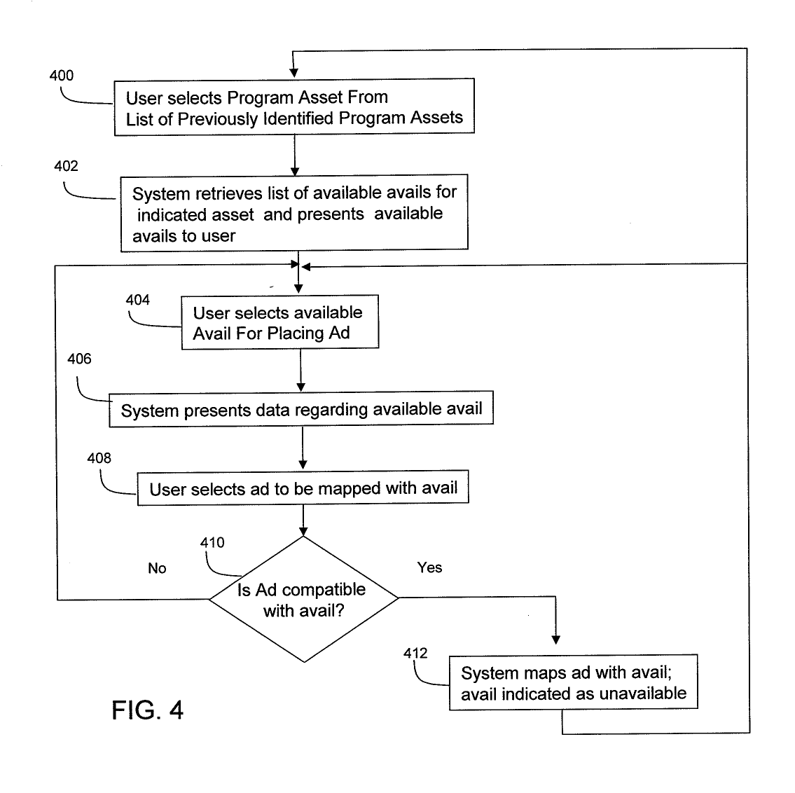

Manual mapping refers to individually mapping a particular ad to a particular avail of a particular program, usually for broadcast programming. This process is suitable when a limited number of mappings are to occur. An alternative process, automatic mapping, is possible where the Ad Broker performs the mapping and can be used when there is a large number of mappings to occur. The process of manual mapping is usually used only for scheduled broadcast programs, as evident from the following discussion. This process allows the Ad Purchaser (“user”) to map an ad to an avail is shown in FIG. 4. This process presumes that an appropriate graphical user interface is provided to the user, allowing the user to select a particular program asset, an ad, and view related information. The process begins in step 400 with the user selecting a particular program asset from the list of program assets planned for the Ad Campaign. Once the Ad Broker is aware of the particular program asset involved, it can then ascertain how many avails are associated with the program asset and how many are available. The Ad Broker can then graphically display this information to the user. Typically, the Ad Broker does not display specifics regarding unavailable avails to the user, unless the unavailable avail is allocated to the user. Thus, the Ad Purchaser is unable to view details on other ad purchaser's ad campaigns. An unavailable avails can be selected and have its details presented to the user in step 406. These details include:
Avail identifier,
Avail time length,
Avail location within the programming asset, and
Type of avail (national or local).

In the next step, 408, the user selects a particular avail for mapping with an Ad. Then, the user then selects the particular Ad in step 406 that is to be mapped to that avail. At this point, the Ad Broker can then map the Ad with the avail, and determines whether the ad is compatible with the avail. For example, the time length of the ad may be incompatible with the avail (e.g., the ad is 30 seconds long and the available time is a maximum of 15 seconds). There may be other requirements, such as whether the ad is in the correct format (e.g., high definition versus standard definition, audio format, etc.). If the ad is not compatible, then the user is prompted to return to step 404 to select another avail. If the ad is compatible, the Ad Broker maps the ad to the avail, then flags that avail as unavailable, and then prompts the user to either select another avail, or another ad for mapping another avail within the same program. This process continues until the user completes mapping all the ads to available avails.

The Ad Broker system may enforce various parameters in a particular ad plan level established for that Ad Purchaser, or for that campaign. For example, if the Ad Purchaser agreed to an ad plan allowing only 15 avails to be selected, the Ad Broker will not allow the user to select 25 avails. Or, for example, if the Ad Purchaser has purchased a maximum amount of advertising time, the Ad Broker will ensure that the aggregate amount of ad time for this particular ad campaign will not exceed a pre-established limit.

### Automatic Ad Mapping

Automatic mapping facilitates the process of mapping an ad to a program. It can be used in two instances: first, for broadcast or scheduled programs, and second for on-demand programs.

Automatic Mapping for Scheduled Programs

If an Ad Campaign involves mapping between numerous ads and programs, the specific mapping may be onerous or time consuming to define manually. In such instances, the Ad Broker can place the ad according to various algorithms. In one algorithm, the Ad Broker will select the first ad and map it to the first avail each qualifying program in a serial manner. Once all the qualified programs have been mapped, the second ad to be placed is selected, and placed in the next available avail in the first qualifying program, the next qualifying program, and so forth.

Another algorithm is to select the first ad and map it to the first available avail in a qualifying program. Then, the second ad is selected and mapped to the next available avail in the same qualifying program. If there are no more avails in the program, then the next qualifying program is used, and so forth. Another variation is to place the first ad in the first avail in the first program, the second ad in the first avail of the second program, and so forth. It is possible to create a number of algorithms, other than those indicated above. It is also possible for an Ad Purchaser to have the Ad Broker perform the automatic mapping, and then review the results and manually alter select mappings.

Automatic Mapping for Video On Demand Programming

By definition, on-demand programming is not scheduled as is broadcast programming, hence a particular ad cannot be scheduled to be streamed at a given time. However, at an aggregate level, a service provider may be aware of the average number of viewer requests for on-demand viewing, and the average number of avails and advertising time that are available for ad placement.

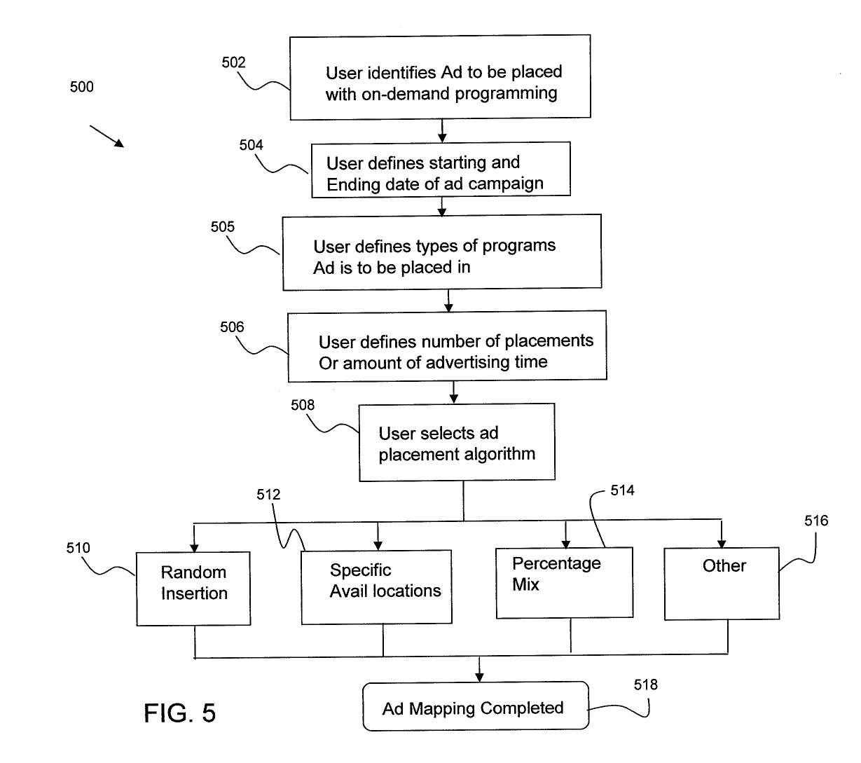

Consequently, the Ad Broker interacts with the Ad Purchaser differently, but still requires some information in order to perform dynamic mapping automatically for the Ad Purchaser. This process is reflected in FIG. 5. One embodiment of the process is represented by process 500 of FIG. 5. In FIG. 5, the process begins with step 502 with the user identifying the ad involved. Typically, this can be done by presenting to the user with the various ads stored in the Ad Broker, and allowing the user to select one. In this embodiment, the user selects the “Hiking Kids” ad. Alternatively, the user can merely identify the file by file name or other means. In step 504, the user provides the beginning and ending dates for which the ad is to be inserted in on-demand programming. This information may have been previously indicated with the ad campaign details, and hence is optional. In step 505, the user may provide information about the type of programs the ad is to be place in. This could be indicated by indicating a list of titles, defining certain ratings categories (or excluding certain ratings categories), etc. In step 506, the user indicates the amount of ad placement that is desired, which can be indicated by providing a number of times the ad should be shown, or an aggregate time length that the ad should be played. In other embodiments, a number of ads may be involved with different run times, so that it may not be defined as to which ads are played how many times.

In step 508 the user selects an ad placement algorithm, which provides guidance to the Ad Broker as to how the mapping is to occur. Typically, there may be a number of options, and only a few are illustrated here. In one algorithm 510, the Ad Broker may randomly assign the ad to one or more avails of the indicated program(s). In another algorithm 512, the Ad Broker may assign the ad only to certain avails, such as an opening or closing avail associated with the indicated programs or program types. Another type of algorithm shown in step 514 is to assign a percentage mix. This can assign an ad to different types of avails, based on a percentage definition. For example, the ad can be assigned 50% of the time to an opening avail, and 25% of the time to a middle avail, and 25% of the time at a closing avail. Other algorithms are possible and represented by step 516.

The indication of the above information can be accomplished by text fields, pull down menus, selecting options using a cursor, etc. The manner of input can be accomplished in a variety of well known techniques.

### Reserving Avails

A possible timing dilemma can occur with respect to an Ad Purchaser desiring to place ads in a VSP for an advertising campaign. The Ad Purchaser may wish to structure a campaign for certain times contingent on obtaining advertising campaign for various avails from various providers. Alternatively, certain avails may be desired to be used in the campaign, but a completed video clip is not available to map to the avail. For example, a business may decide to initiate a campaign in the future, but commitment to initiating this campaign is contingent on development of a suitable ad video for the campaign. However, committing to development of the suitable ad video is contingent on obtaining the desired advertising time with the VSP. In some cases, these commitments are difficult to occur simultaneously, but the mapping process requires mapping a video clip to avail in order to make the avail unavailable to others. Further, other ad purchasers may select desired avails. One approach is to create a “dummy” video clip which an Ad Purchaser can map to an avail, and then later substitute another video clip. This can be done by merely editing the name of the mapped ad campaign. Another solution is to allow an Ad Purchaser to reserve certain avails without requiring mapping of a particular ad for placement in the avail at the moment. Thus, the avail space can be “held” for an Ad Purchaser. It is possible to allow the profile of the Ad Purchaser to reserve an avail for scheduled ad placement for a limited amount of time prior to the program being streamed. An Ad Purchaser can reserve avails for a program several months in advance, and if an ad is not mapped within a certain time period (e.g., 3 days prior to the scheduled event), the Ad Broker (or the VSP) may reserve the right to cancel the reservation and allocate the avails to some other ad purchaser's ad. In various embodiments, a deposit or fee can be charged for reserving an avail, with additional “cancellation” fees if it is not mapped to an ad by the required time.

### Ad Campaign Approval

Once the various parameters associated with an Ad Campaign are entered, the Ad Purchaser is offered the opportunity to commit (approve) to the parameters. Until this point, the Ad Campaign is in a draft state, and parameters can be altered, within allowed limits. Once the campaign is approved, then system ensures that all the necessary data is present, that it is compatible, finalizes any mappings, etc. After the Ad Campaign is approved, it is in the active state. While the campaign parameters can be viewed, any altering will place the campaign out of the active state, and it must be re-approved to re-enter the active state.

After approval, the Ad Broker will interact with the appropriate VSPs to provide the parameters to their respective ad management systems for the Ad Campaign. The Ad Campaign may require interaction with multiple service providers, and dependent on the particular interface offered by the service provider.

### Ad Campaign Execution Phase

The Ad Campaign Execution Phase refers to actually initiating and executing the ad campaign. At a high level, this can be considered as the time period beginning with the beginning of the streaming of the first ad and ending with the streaming of the last ad. This is typically defined by the time period that defines the ad campaign. In the case of scheduled broadcast programming, the first ad is known to be scheduled at a given time, and hence the beginning of the program can be known in advance. In the case of on-demand programming, it is not known when the first ad will be placed, although it would be on or after the start date of the campaign. Thus, it is presumed the execution phase of the ad campaign begins on the start date, even though the first ad may not be streamed on this date.

Various aspects of the actual insertion of the ad occurs in the equipment of the various service providers. In some embodiments, the Ad Broker can directly interface with the equipment in the service provider for accomplishing such function.

### Event Reporting

Events are defined as actions or activities that pertain to a campaign. The Ad Broker receives various indications from the video service provider confirming receipt of ad parameters, establishment of schedules, acknowledgment of ad campaigns start dates, etc. The events include normal conditions, such as the playing of an ad, as well as exceptional conditional reporting (e.g., failure to map an ad, insert an ad during streaming of a program, etc.).

The Ad Broker may be configured (based on the Ad Purchaser's profile) to report events to the Ad Purchaser. Further, different types of significance levels can be designated as being reported. Thus, the normal playing an ad may be categorized as a low priority, but failure to place an ad may be categorized as a high priority. The Ad Purchaser may be able to select a priority level for being informed of events.

### Ad Campaign Reporting Phase

The Ad Broker collects various events, which may or may not be reported individually to the Ad Purchaser. However, the events are aggregate by Ad Purchasers in order for the Ad Broker to generate various types of reports pertaining to the ad campaign. Typically, the Ad Purchaser can select from a variety of formats and content, including:
a. Summary of ads actually streamed in a campaign (all sites); and
b. Summary of ads streamed for a particular site in a campaign.
   These reports typically indentify the number of times ads are played, total playing time, programs that are mapped with the ads, content providers were involved, when the ads were played, etc.

The Ad Purchaser can access a report during an ad campaign, as well as after completion of the Ad Campaign. These reports provide a basis for the Ad Purchaser to confirm performance of any contract formed with the Ad Broker or video service provider, as well to as confirm performance associated with billing.

### Billing

Billing refers to the process of computing a fee associated with the performance of the Ad Campaign. The Ad Broker does this in one embodiment by using the event reported to determine a fee based on a previously established schedule. Thus, it is possible that each event corresponding to streaming an ad increments a fee charged. Alternatively, the aggregate amount of ad time is determined and fee is calculated according to a fixed scheduled. In many instances, the performance of an Ad Campaign associated with on-demand programming cannot be evaluated until the completion, and the events are used to determine an aggregate amount of time the ads are streamed. Further, even in the embodiment of scheduled ads, the placement of ads may not occur as scheduled. This can be due to system errors, operator errors, or last minute schedule alternations which disrupt an advertising schedule (e.g., an emergency newscast). These events may result in a lower than otherwise calculated fee.

Billing may be predicated on meeting certain threshold levels, such as aggregate ad streaming times, or meeting a certain level of scheduled ad placements. The fee rendered may be adjusted up or down based on the actual amount of ads streamed in conjunction with an Ad Campaign.

### Ad Placement Architecture

The Ad Placement architecture is shown in FIG. 2. In this case, the main components involve the Ad Broker system 200 interacting with one or more video service providers. In this embodiment, a single video service provider is shown in the context of a cable service provider 250. The CSP 250 comprises various set top boxes 252 connected to a cable distribution network 254 that in turn is connected to a headend 256. The CSP also includes various equipment for providing programming 258 (including VOD and broadcast programming), and an ad management system 260. The Ad Broker 200 communicates with the ad management system 260 in order to provide the necessary campaign parameters, ad files, etc. necessary for the CSP to stream the ads.

In other embodiments, the CSPs ad management system can be incorporated into the Ad Broker system 200, so that the Ad Broker directly manages the placement and streaming of ads to the cable headend.

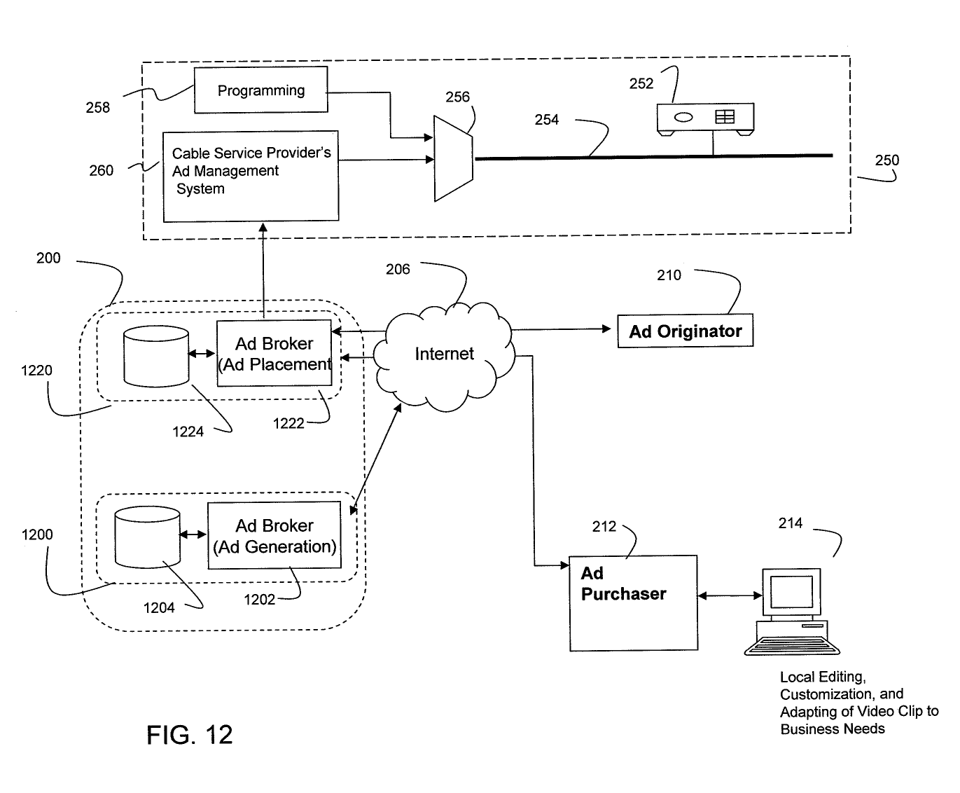

An alternative embodiment of the system is shown in FIG. 12. In this embodiment, the Ad Broker system 200 can be implemented with two separate subsystems. A first subsystem 1200 comprises a server 1202 and associate data storage 1204, which provides the ad generation related capabilities. The second subsystem 1220 also comprises a server 1222 and associated data storage 1224. The second subsystem 1220 provides the ad placement related capabilities.

Thus, the Ad Generation phase involving the Ad Originator 210 posting a video, and the Ad Purchaser 212 browsing and purchasing a video involves the first subsystem 1200 interacting using the Internet. Then, when the Ad Purchaser is ready to place the ad, the Ad Purchaser interacts with the second subsystem 1220. The second subsystem 1220 also interacts with the cable service provider 250. In some embodiments, the functionality of the first subsystem 1200 can be provided by a third party, which provide capabilities of posting, viewing, and downloading video clips.

### Module Architecture

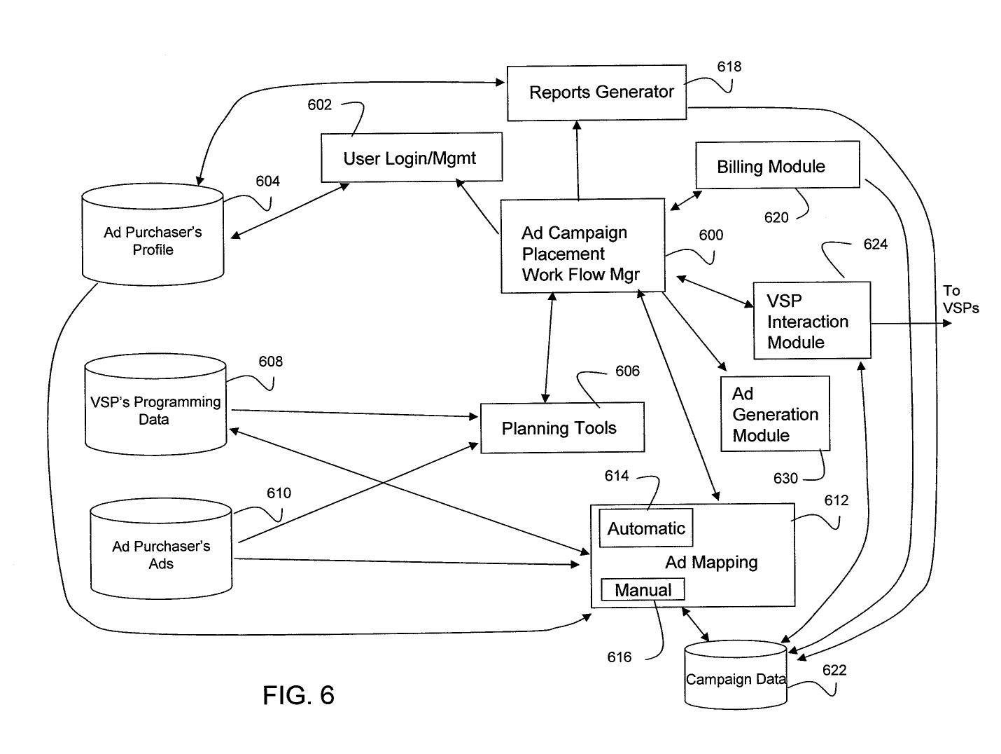

The above capabilities can be provided using software modules executing in a system as described below. However, the specific modular architecture can vary in different embodiments, and one embodiment in shown in FIG. 6, which in turn is based on the architecture shown in FIG. 2.

In FIG. 6, the main process of the Ad Broker is the Ad Campaign Placement Work Flow Manager (“Work Flow Manager”) 600. The Work Flow Manager coordinates all the other processes, and ensures that the necessary modules operate and are available to complete the ad placement. Thus, the Work Flow Manager interacts with the other modules as shown.

The first module that an Ad Purchaser usually interacts with is the User Login/Management modules 602. This is used to establish the user's profile, which is stored in a data store and illustrated as Ad Purchaser's profile 604. Any information specific to the user may be stored here, and the user can typically view much of the data, and in some cases update the data. Once the user has established an account/profile, the user can then interact with the other modules.

The next module that the Ad Purchaser may interact with is the Ad Generation Module 630. The Ad Generation Module provides the capabilities of interacting with an Ad Originator allow the uploading of ads that can be selected. The Ad Generation Module also interacts with the Ad Purchaser to allow viewing of these ads, as well as the effective purchasing of the ads. The Ad Generation module also enforces the security of the ads once they are purchased by the Ad Purchaser. This module may also receive edited ads from the Ad Purchaser, and may generate the Ad Asset (e.g., the ad video in a package form having industry compliant metadata and otherwise transformed into a compatible asset (such package formats which are used by cable service providers). The Ad Generation Module may also handle payment and remittances between the Ad Purchaser and the Ad Originator.

After an ad is present in the Ad Broker for the Ad Purchaser, the next step is to establish an Ad Campaign. In order to establish an Ad Campaign, a user will typically utilize the Planning Tool module 606, which provides the ability for the user to read and review various data either stored in the Ad Broker, or accessible by the Ad Broker. There are two common types of data that the user can access. First, the Ads previously uploaded by the Ad Purchaser are stored in the Ad Broker system and represented as contained in a data store of the Ad Purchaser's Ads 610. The user may have as few as a single ad, but in many cases will have several ads stored. The Planning Tool module only allows the Ad Purchaser to view their own ads, and not that of other users. The second type of data that the Planning Tool module provides to the user is access to various programming related data for one or more VSPs. The planning tool provides mechanisms for searching and filtering of programming data allowing the user to view selected programs, service providers, content providers, programming, times, etc. The Planning Tools may incorporate information in the Ad Purchaser's profile 604 to facilitate filtering of the information.

Once sufficient planning information is known, the user may utilized the Ad Mapping module 612. Unlike the Planning Tool which only allows reading of information, the Ad Mapping Tool sets parameters in various data stores, including the Campaign Data store 622. The Ad Mapping modules accomplishes the effect of mapping an ad to an available avail as discussed previously, and may include an automatic mapping sub-module 614 and a manual mapping sub module 616. The Ad Mapping module is able to access the Ad Purchaser's Ads in data store 610, as well as programming data from one or more VSPs. The latter capability allows the Ad Mapping module to determine which avails, programs, etc. are available for mapping the ads.

Once the ads have been mapped to programs, the Workflow Manager 600 then instructs the VSP Interaction module 624 to place the ads with the appropriate service provider(s). The user typically does not interact with the VSP Interaction module. The Ad Broker uses various types of application programming interfaces to communicate with the various service providers as necessary. In one embodiment, the VSP Interaction modules interacts with an ad campaign manager or other device to inform the VSP as to what ads are mapped, and download the ads if necessary to the VSP. The VSP Interaction module also may receive reports from the VSP as to when the ads are played (or failure to do so), so that the corresponding events can be recorded for that user's campaign related data in the Campaign Data data store 622. The user typically does not interact with the VSP Interaction module. In one embodiment, the VSP provides the campaign data to the VSP in a format conforming with an industry standard, such as that defined in the CableLabs® SaFI Specifications, Campaign Information Package Specification, CL-SP-SaFI-CIP-I01-090626, dated Jun. 26, 2009, the contents of which is incorporated by reference.

The user may interact with the Reports Generator module 618 which provides notifications to the user regarding events and occurrences which may require user attention. The Report Generator periodically processes the data reported in the Campaign Data data store 622 for the user, and may access the Ad Purchaser's profile 604 to determine how to contact the user.

The last module shown if the Billing Module 620 which also interacts with the Campaign Data data store 622 to determine how many ads were actually placed, which may impact the amount of the bill for that user's ad campaign. For example, recall that the placement of ads for on-demand programming is based on expected showings of various programs. It is possible that the expected number of ad placements did not occur, and the fee included in the bill is determined based on the number of actual ad placements.

The above represents the main modules of the Ad Broker system. Any of the capabilities which are not explicitly identified with the above modules can be included in the above modules as appropriate, or can be included in separate distinct modules, and be within the principles of the present invention. For example, the ability of a user to terminal a campaign could be offered in the Planning Tool Module, or the User Login/Management module. Further, not shown in FIG. 6 is the Administrator's control module that allows access and control to various parts of the system, which provides “super-user” capabilities, and allows access to each of the user's data and information. Further, the logical organization can be mapped to physical embodiments in various ways. For example, various data stores (e.g., campaign data 622, Ad Purchaser's Ads 610, etc.) can be implemented in a single or multiple physical data stores.

The VSP Interaction module is the module which interfaces with the video service provider. In some embodiments, the VSP will interact with more than one VSP, such as a plurality of cable systems that can be associated with one or more cable service providers. Such communication occurs via Internet or other communication facilities.

One aspect of the VSP interaction module is to accomplish the transfer of the Ad Asset from the Ad Broker to the VSP (this presumes that there is an ad management system in the VSP). The VSP typically requires the ad to be provided as an Ad Asset, e.g., the video clip has been transcoded and formatted so as to be compatible with its various systems. In one embodiment, this requires the Ad Broker to provide the Ad Asset as a package as defined in the aforementioned CableLabs® specification. In this embodiment, the Ad Asset has a defined digital video file structure and metadata reflecting the coding of the digital video file along with the required necessary metadata fields. In some embodiments, the Ad Broker will prompt the Ad Purchaser for information to populate such fields in order to generate the Ad Asset as a package conforming to an industry standard. These prompts may occur at various times during the process. Alternatively, the Ad Purchaser could provide the ad video in a compatible package format.

The VSP interaction module typically interacts with the ad management systems which are in place in the VSP. In some embodiments, the ad management systems allow users to map ads to avails for scheduled programming. However, these ad management systems typically presume the user is an authorized administrative personnel of the service provider. Thus, the capabilities present in an ad management tool (specifically, provided in an interface to the VSP ad management system) in a VSP are not suitable for providing an “open” interface to a prospective ad purchaser. For example, the VSP ad management system may readily allow access to all ads that are to be mapped. While it may be acceptable for administrative personal at the VSP to be able to view all possible ads that are to be played, it would not be acceptable to allow a prospective ad purchaser to view such ads. Doing so would allow new ads to be previewed by third parties before they are streamed. Thus, for example, ads scheduled for an upcoming championship football game should not be viewable by potential business competitors planning ads as well. Thus, one function performed by the Ad Broker is to screen access so that the Ad Purchaser can only view those ads which are associated with the Ad Purchaser, and to shield details of the placement of the ads by others. Thus, the Ad Broker uses the Ad Purchaser identifier and/or profile information to screen information and limit certain capabilities to the Ad Purchaser which would not be otherwise limited by accessing the VSP's ad management systems. These functions include:
limiting presentation of ad details to an Ad Purchaser for unavailable avails;
ensuring that only the proper Ad Purchaser can view the ads in the Ad Purchaser's library (e.g., other ad purchasers cannot view them);
prohibiting Ad Purchaser to directly access capabilities in the VSP's ad management systems;
providing and enforcing ad campaign plan parameters for the Ad Purchaser during the ad mapping process (a VSP would not purchase ad time from itself, so there are often no limitations defined for mapping ads within the VSP);
Providing a limited time “reservation” function of ads in a VSP.

### Physical Architecture of Ad Broker System

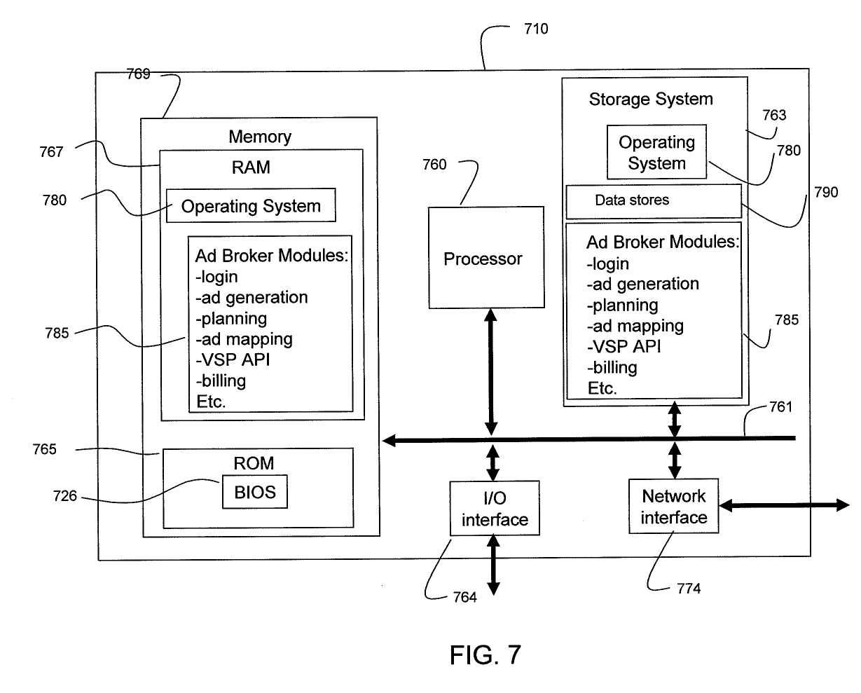

The Ad Broker system is typically embodied in a computing system, such as a server system hosting a web site. FIG. 7 illustrates one embodiment, but other embodiments using other computer configurations are possible, using distributed or paralleling processing systems, or special purpose computing systems. In FIG. 7, the system 710 comprises a number of components including a processor 760 that executes the stored program computer instructions that are found in the storage system 763 and the memory 769. The storage system 763 typically comprises secondary or long term memory, typically in the form of disk drives or other recordable medium, but may comprise tape, CD or other such mediums. The storage system typically retains a copy of the operating system 780, and the various ad broker software modules 785, which were discussed previously. The storage system also stores various data stores 790, which comprise the aforementioned Ad Purchaser's Profile 604, VSP Programming data 608, Ad Purchaser Ads 610, Campaign Data 622 from FIG. 6, as well as any other data required to be stored. The processor communicates using an internal buss 761 with the storage system 763, as well as with primary memory 769. The primary memory typically comprises a RAM type memory 767 and may include various types of ROM memory 765. The RAM memory 767 stores working copies of the operating system 780, and the various previously described modules 785. These comprise the various computer instructions that provide the aforementioned capabilities. The ROM section 765 may comprise various types of read-only memory, and store instructions such as a BIOS 726 routine used when starting up the system.

The system comprises an input/output interface 764 which also shares the communication bus 761 as well as a network interface components 774, which provide access to various communication networks. Other components or alternative architectures are possible, and the figure only represents one embodiment.

### Typically Application of the System

A typical application of the Ad Broker system is now described. This represents one embodiment of the invention, and is not intended to limit the scope of the invention. In this embodiment, a local merchant acts as an Ad Purchaser and desires to place two different ads in a variety of ad spots with a local cable service provider.

The merchant uses a personal computer to access a web site of the Ad Broker. At this point, creating an account is not required as the merchant is accessing the web site to see what, if any video clips could be suitable as ads. However, in this embodiment it is presumed that the Ad Purchaser has created an account and has logged in. In pursuing the selections, it is assumed that the merchant is aware of a well known independent producer of video clips for commercials. In one embodiment, the user is presented a series of thumbnail images representing an image of a video clip, each with a brief description of the name of the video clip (typically a descriptive name), a source of the video clip, and a run time. The merchant searches for such clips by using well known word search techniques indicating the producer's name and/or subject matter of the video clip. The merchant is able to determine there are video clips of interest.

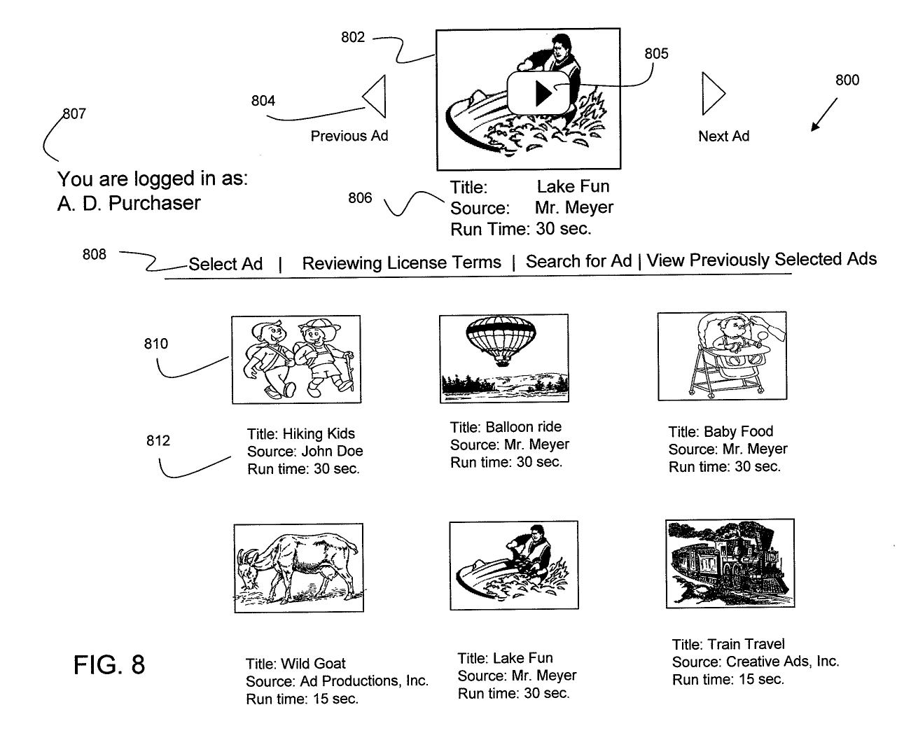

One embodiment of a web page illustrating potential ad video clips is shown in FIG. 8, where the screen image 800 comprises a series of thumbnail images 810 where each include a brief description 812 of the title, source, and run time. The Ad Purchaser can select any of the images, which is indicated in the top portion 802, with controls for playing the ad 805 or viewing the next or previous ad 804. The selected video also has information about the video clip displayed 806. In this embodiment, a command line 808 is shown that allows the Ad Purchaser to indicates commands for purchasing or licensing an ad, a command to review the associated license terms, search tools for searching for a specific type or source of ad, and the ability to view the ads that have been previously purchased/licensed, which are in the Ad Purchaser's personal ad library in the Ad Broker. In this embodiment, the user has previously created and logged into an account, and this information 807 is reflected in the screen image. The layout and interface characteristics of the graphical user interface can vary in various embodiments.

The merchant may review various ads, view them on-line, and their associated terms of purchase or license. In this example, it is assumed the Ad Purchaser selects and purchases the “Lake Fun” video clip. After agreeing to do so, the ad can be selected for downloading. It is presumed that all rights are now vested in the merchant, and that video clip is no longer available for selection by others. In some embodiments, the Ad Broker tenders payment using a credit card or account associated with the Ad Purchaser, and then restricts access to the video clip only to the merchant.

After downloading the video clip, the merchant can use a local copy of the video clip to edit it to include the appropriate voice-over and graphic images associated with the merchant. The copy provided to the merchant after purchasing/licensing is a high resolution version of the ad, whereas any copy provided for initial viewing of the ad prior to purchase is a low-resolution version. In many embodiments, the merchant will edit the video clip, potentially adding additional video images, background music, sounds, or voice. Once editing is completed, the merchant uploads the video clip into the Ad Broker to be stored in the Ad Purchaser's “personal library”, which again is only viewable by that merchant. In addition, the merchant may upload a second commercial, or may already have a second commercial stored in the Ad Broker system in their personal directly. Thus, once the Ad Purchaser has completed uploading of both ads in their personal library the ad generation phase is completed. For illustration purposes, it is assumed the Ad Purchaser has obtained rights to the “Lake Fun” video clip and to the “Hiking Kids” video clip as the first and second ad respectively.

Next, the merchant desires to place these two ads in a local cable system as part of an advertising campaign. The first ad is to be inserted in conjunction with the local evening news programs, whereas the second ad is to be inserted with on-demand showings of a movie that is scheduled to be available on the cable system. In this embodiment, the Ad Broker system is able to provide the merchant with various advertising “plans.” In the case of the first advertisement, an advertising plan is offered to the merchant that involves the placement of 50 showings of a particular 30 second ad within various local morning or evening news programs. The ad can be placed at any available day over a period up to 4 weeks in advance. The placement of the second ad in conjunction with the on-demand movie provides for up to 100 placements of the ad in the first three avails at the beginning of the program. In this embodiment, the merchant can potentially select a particular on-demand movie title the ad is to appear in. The merchant would like the streaming of the ads to occur co-incident with a marketing promotion over a two week period leading up to a special sales event.

To begin the ad placement phase, the merchant then logs back onto the Ad Broker system again. Because the first ad is to be placed in conjunction with scheduled broadcast programming, the Ad Purchaser invokes the Planning Tool module to review the schedule of the broadcast news channels and available avails. It is presumed the merchant has previously established a profile so that only programming from the desired cable service provider in the relevant market is shown. Further, because the merchant only advertises on local news stations, only the programming is displayed from the three local content providers (e.g., local news stations corresponding to affiliates of national broadcasters).

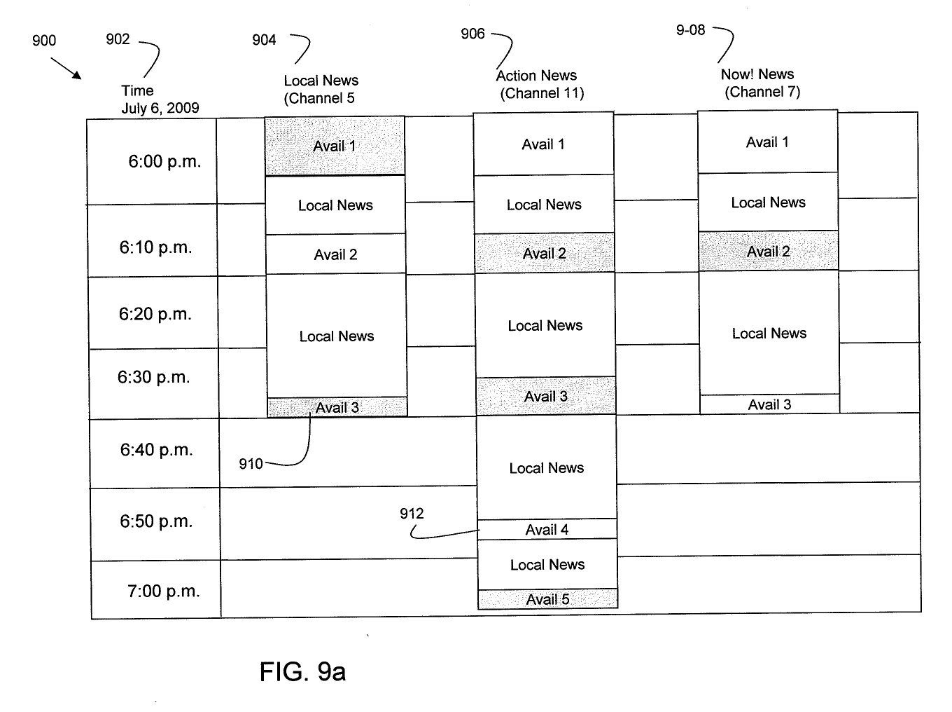

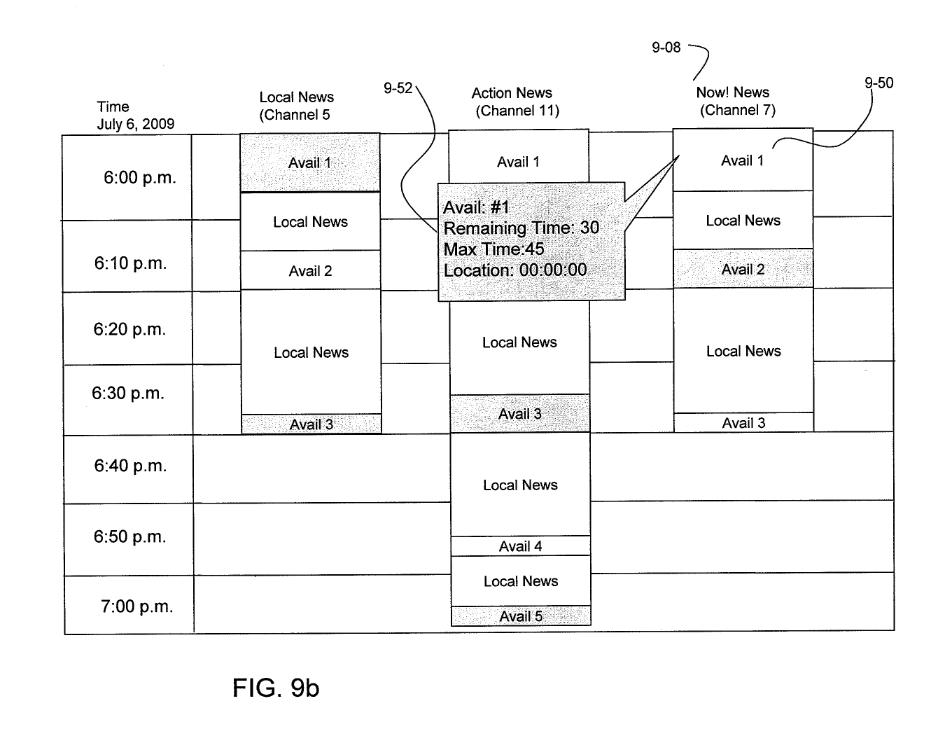

The merchant can view the available avails for the broadcast programming on a screen image 900 such as shown in FIG. 9a. In FIG. 9a, the image comprises a column indicating the time 902, which can be scrolled up or down to view the different times during a day. Menu options for viewing different days or times can be provided to allow easy navigation of the different avails at different time. The other columns 904, 906, and 908 show the desired Content Providers and the appropriate sites. The filtering of information allows the merchant to focus on only those avails of interest. As can be appreciated, in circumstances where the cable service provider offers over a hundred channels or different sites, the filtering facilitates Ad Purchaser planning by limiting information presented.

The programming can be displayed with the associated avails identified. The avail indicates that one or more ads have been, or can be, placed in the avail. In this embodiment, shown in FIG. 9a, the avails are merely identified in numerical order for each channel, with the number resetting on the hour to facilitate illustration. Hence, the avails begin with avail #1 at 6:00 p.m. for each service provider. The avails which have been previously mapped to one or more ads (and hence are not available for mapping) are shown in shaded or colored form, so that these are readily perceived by the Ad Purchaser as not being available for selection. The avails which are not shaded represent available inventory and thus have capacity to be mapped to an ad.

Once the merchant has obtained sufficient information to plan an ad campaign, the mapping of the avails to the ads can occur. The user selects a particular available avail, and can view available capacity. For example, in FIG. 9a, the user may place a cursor or pointer over the avail 950 for the Now! News channels 908, which results in a pop-up window 952 indicating that the Avail is identified as Avail #1, with a location at the very beginning of the program (e.g., 00:00:00 hours, minutes and seconds into the program). Further, the pop-up window indicates that the avail has a total of 45 seconds of ad time, and there are 30 seconds remaining (hence, another ad of 15 seconds has been placed in this avail). The user may select the avail if this is the desired location.

After selecting the avail, the user then selects one of the ads stored in the Ad Broker (in this illustration, the “Lake Fun” ad) and indicates that this ad is the one to be placed in the indicated avail. The Ad Broker then decrements the available time based on the amount of the ad, and if the ad has no more time left, the avail is then marked as unavailable. The Ad Broker determines the time based on the run-time indicated by the metadata in the ad. This process continues until the maximum purchased ad time is consumed by that user, or the Ad Purchaser determines that the process is completed.

Recall that in this embodiment, the user also had a second ad that to be placed (the “Hiking Kids” ad), but which was to be placed in conjunction with on-demand programming. In this embodiment, the indication of how the ad is to be mapped with the programming is different because the programs are not scheduled.

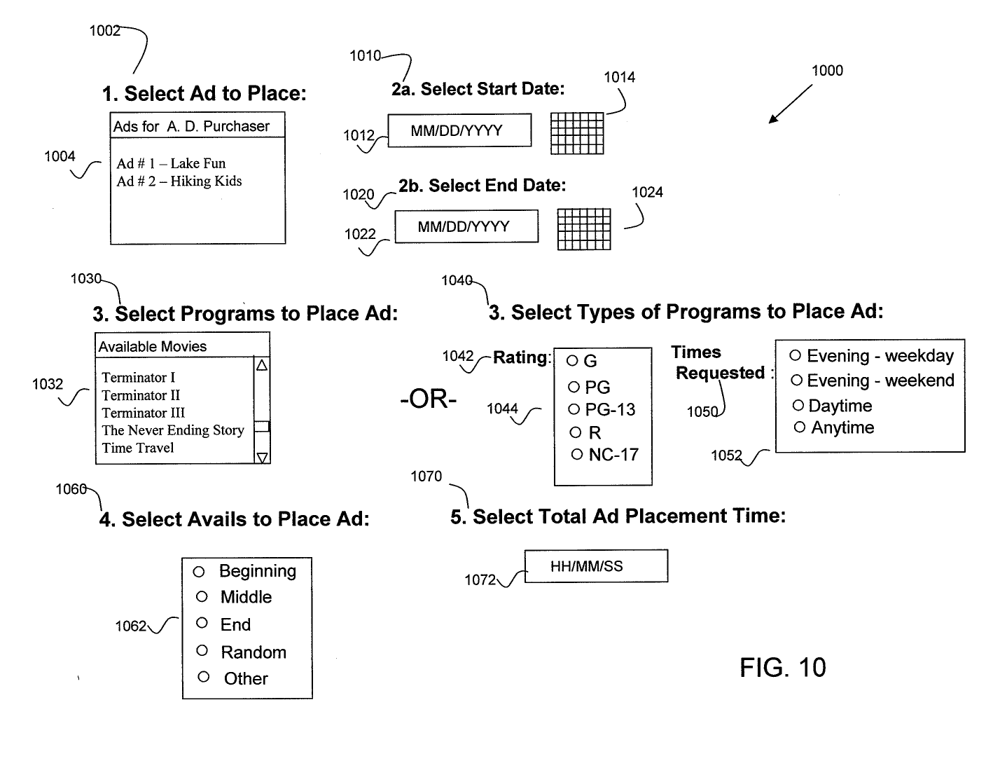

One embodiment of a screen image associated with a graphical user interface for providing information to the Ad Broker for mapping an ad to an on-demand program is shown in FIG. 10. In FIG. 10, the user begins by first indicating which of the Ad Purchaser's ad is to be placed. This is shown in section 1002 which lists the ads associated with that Ad Purchaser, and in this embodiment the file listing 1004 displays two ads. These display the names of the titles associated with the ads, which was stored in the ad's metadata.

The Ad Purchaser then provides the dates for which the ad is to be involved. This is shown in the “Select Start Date” 1010 and the “Select End Date” 1020 areas of the screen. These portions prompt the user to enter a start date 1012 and an end data 1022, and may provide a calendar assistance icon 1014 and 1024 in determining the dates.

Next, the user selects on-demand programming to be mapped to the ad. This can occur in various ways, and only one embodiment is shown where the user can select either specific programs 1030 or types of programs 1040. In the former case, the user can select one or more names from a list of movie names 1032 which represents available on-demand programming. This list can be quite lengthy, and so there is an alternative approach where the user selects certain types of movies. In another area 1040, the user can select certain programming based on rating type 1042, which incorporates various ‘radio buttons’ for selecting various rating levels 1044. In addition, the user may be able to select certain times 1050 the ad is to be mapped when the program is being requested. These times also include various radio buttons 1052 indicating weekday/weekend or other options.

Next, the user selects the type of avails where the ad is to be placed 1060. This also include various radio buttons indicated the relative location of the avails 1062 in the requested program. Finally, the user is prompted in area 1070 to provide the total amount of ad placement time is desired. The “ad placement time” refers to the time length (typically indicate in hours, minutes, seconds, or some combination) of the total time for playing ads in the Ad Campaign. Typically, this parameter is directly related to any fees charged, as it is one measure of the level of service provided to the Ad Purchaser. Since the user desired 100 placements, and assuming the ad is 30 seconds long, then 3000 seconds of ad placement time is indicated (50 minutes).

The above represents one embodiment of various options which can be defined for allowing a user to specify certain criteria to use in associating an ad with a program. Many other variations are possible, including specifying certain criteria to better target an ad with a viewer, including excluding mapping an ad to a program type (e.g., no ads are to be mapped to NC-17 rated movies), indicating a plurality of titles (including all movies released in the last month), specifying demographic data (all viewers in a certain zip code), etc. Thus, any of the known criteria for targeting an ad to a viewer in a cable system for on-demand programming could be incorporating in the Ad Broker.

Once the proposed mapping schedule and criteria are provided, the user approves the Ad Campaign. The Ad Campaign is ready for execution, and the Ad Broker interacts with the appropriate cable service providers to ensure the mapping, ads, and other data is stored in each CSP. The user may elect to receive various notifications of events that occur during the interaction with the CSP, or during the campaign, but assuming that the campaign completes normally, the user will then be billed for the placement of the ads. To ensure the terms of the contact have been satisfactorily performed, the Ad Broker will make available a reporting on the Ad Campaign.

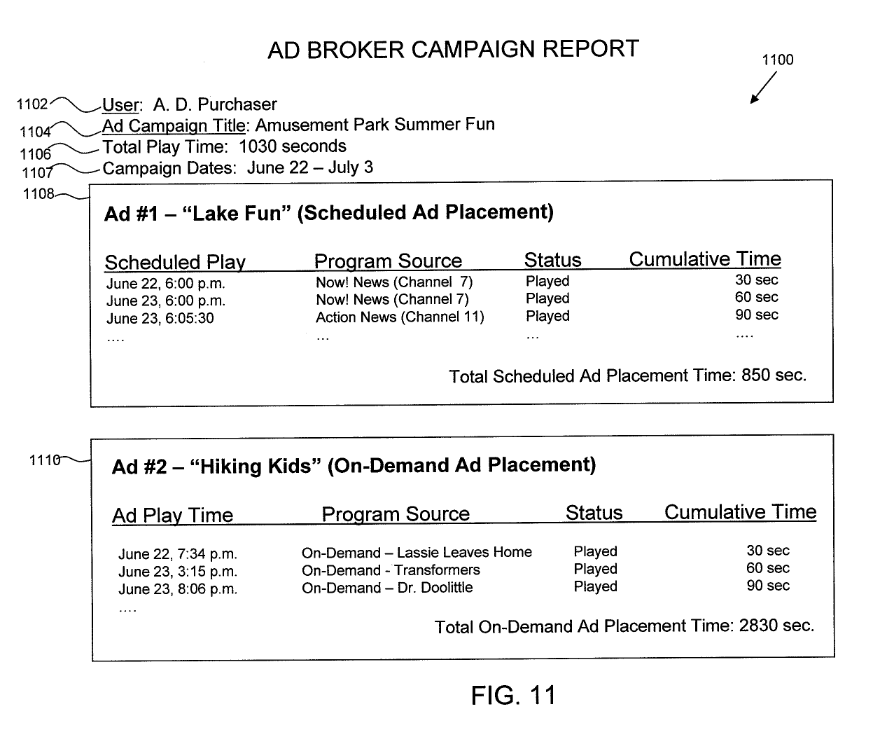

One embodiment of the Ad Campaign report is shown in FIG. 11. In FIG. 11, the campaign report 1100 comprises an identifier 1102 of the Ad Purchaser (“A. D. Purchaser”) and an identifier of the Ad Campaign title 1104 (“Amusement Park Summer Fun”). It is possible that the Ad Purchaser may have several ad campaigns handled by the Ad Broker, which is particularly possible if the Ad Purchaser is providing a service to other users. The report typically includes other information about the campaign, such as the start and end dates 1107. Other information can be presented as well, but is not shown in FIG. 11.

The report provides detailed information about each ad involved in the Ad Campaign. In this embodiment, there were two ads selected for placement—the “Lake Fun” video clip which was mapped to broadcast programming. This is indicated in section 1108, which provides information about this ad, when it was scheduled, what program sources were indicated, whether the ad was actually played, and the cumulative played time. Since this was a scheduled for certain program sources and times, it can be easily verified whether the ad played in each instance. A cumulative time shows the aggregate amount of advertising time that occurred. If the ad had not played (for whatever reason), the “status” field would indicate “not played” and the aggregate time would reflect this.

In addition, the other portion of the campaign report 1110 indicates when the second ad, “Hiking Kids” was mapped to an on-demand movie. In this embodiment, it was mapped to three on-demand programs, and the times of which are indicated. The titles of the programs which were used are indicated, as well as the cumulative play time. In this example, the total play time was 2830 seconds, which is slightly less than the targeted 3000 seconds. It is possible that the bill can be adjusted to reflect a corresponding reduction in the fee.

There are various ways in which the reports can be structured and indicated to the user. For example, with the scheduled ad placement, a visual schedule of the times when it was shown can be presented, along with other statistics regarding average number of viewers, third party ratings of the popularity of the programs, etc. However, the report typically includes basic information indicating what ads were played and when, so that some measurement of the ad campaign performance can be obtained, and verification of the service contracted for was successfully performed.

That which is claimed:

1. A computer readable medium comprising instructions executable by a processor in a data processing system for placing an ad with a video service provider, said computer readable medium instructions adapted for:
receiving a first digital video file at said processor from a first user at a web site;
storing said first digital video file in a memory, wherein said first digital video is accessible to other users of the web site;
providing a second user accessing said web site with a plurality of thumbnail images representing a plurality of video clips wherein one of said thumbnail images is associated with said first digital video file;
receiving an indication from said second user at the web site, said indication representing a purchase request of said first digital video file;
making said first digital video file accessible to second user but not to said other users in response to receiving said indication;
receiving from said second user at the web site a second digital video file wherein said second digital video file comprises at least a portion of said first digital video file;
storing said second digital video file in said memory accessible by said web site, wherein said second digital video file is accessible to said second user but not said first user;
converting said second digital video file by said processor into an ad asset comprising a third digital video file, wherein said third digital video file comprises said second digital video file, said ad asset comprising an encoding format compatible with an ad management system of said video service provider;
receiving at said processor from said second user ad campaign data indicating attributes of an ad campaign, said ad campaign data comprising:
a starting date and ending date of said ad campaign,
an identifier of said ad asset,
a value indicating an aggregate ad placement time, and
a site location identifier indentifying a location of said video service provider where said ad is to be streamed; and
providing said ad asset and said ad campaign data to said ad management system of said video service provider prior to said starting date.

2. The computer readable medium of claim 1 wherein said campaign data comprises a plurality of avail mappings, where each mapping comprises an avail identifier associated with a scheduled broadcast program and said ad asset identifier.

3. The computer readable medium of claim 1 further comprising the steps of:
providing data from the data processing system to the second user, said data identifying a plurality avails associated with a plurality of times for said scheduled broadcast program associated with said site location identifier, wherein at least one of said avails is available for placement of said ad.

4 The computer readable medium of claim 3 wherein a profile stored in said data processing system associated with said ad purchaser comprises information identifying said site, wherein said processor uses said profile to select said plurality of avails of said scheduled broadcast program.

5. The computer readable medium of claim 1 wherein said campaign data comprises an indication that said ad campaign is associated with one or more on-demand programs available to subscribers of the video service provider.

6. The computer readable medium of claim 5 further comprising the step of:
providing data from the processor to the second user, said data providing a list of titles of on-demand programs associated with said location.

7. The computer readable medium of claim 1 wherein the step of providing said ad campaign data to said video service provider further comprises providing a second identifier of a second ad asset associated with the ad campaign.

8. The computer readable medium of claim 1 wherein said ad campaign data indicates a preferential avail location for placing said ad asset with a program provided by said video service provider to subscribers of the video service provider.

9. The computer readable medium of claim 1 wherein said ad asset comprises meta data comprising a description of said ad asset.

10. The computer readable medium of claim 1 wherein said data processing system provides to said second user after said ending date of said ad campaign, report data comprising data identifying said ad asset, a time when said ad asset was streamed, and a program identifier associated with streaming said ad asset.

11. A system for placing an ad with a video service provider comprising:
an interface to a communications network, said interface capable of receiving a first digital video file from a first user and a second digital video file from a second user, wherein said second digital video file comprises at least a portion of said first digital video file;
a memory configured to store:
a) said first file received from said first user,
b) said second digital video file received from said second user; and
a processor configured to:
a) receive said first digital video file from said first user,
b) provide said second user with a plurality of thumbnail images representing a plurality of digital video files, wherein one of said thumbnail images corresponds to said first digital video file,
c) receive an indication from said second user indicating a purchase request of said first digital video file,
d) making said second digital video file accessible to said second user for subsequent viewing and inaccessible to said first user for subsequent viewing,
e) receiving from said second user a second digital video file,
f) receiving a request from said second user to place said second digital video file as an advertisement,
g) converting said second digital video file into an ad asset, said ad asset comprising an encoding format compatible with an ad management system of said video service provider,
h) receiving at said processor from said second user ad campaign data indicating attributes of an ad campaign, said ad campaign data comprising:
i. a starting date and ending date of said ad campaign,
ii. an identifier of said ad asset associated with said ad campaign,
iii. a value corresponding to an aggregate ad placement time, and
iv. a site location identifier identifying a location of said video service provider where said ad is to be streamed,
wherein said processor is further configured to transmit said ad asset and said ad campaign data to said ad management system of said video service provider.

12. The system of claim 11 wherein the ad campaign data further comprises a plurality of avail identifiers, wherein each avail identifier is associated with a scheduled broadcast program at the location, and wherein the processor is further configured to communicate said ad campaign data to said ad management system using said interface.

13. The system of claim 12 wherein the processor is further configured to receive said plurality of avail identifiers from said ad management system, said processor configured to receive input from said second user identifying at least one of said plurality of avail identifiers.

14. The system of claim 13 wherein said memory comprises a profile indicating said site location identifier, and said processor is configured to use said profile in requesting said plurality of avail identifiers associated with said site location identifier from said ad management system of said video service provider.

15. The system of claim 11 wherein the ad campaign data further comprises an indication that said ad campaign data applies to placement of said ad asset with on-demand programming.

16. The system of claim 11 wherein said processor is configured to receive a list from said ad management system of on-demand program titles available to subscribers of said video service provider.

17. The system of claim 11 wherein said ad campaign data further comprises a second ad asset identifier and said processor is configured to transmit a second ad asset to said ad management system.

18. The system of claim 11 wherein said ad asset comprises metadata comprising a description of the ad asset.

19. A method performed by a data processing system comprising a processor for placing an ad requested by a user with a video service provider in conjunction with one or more on-demand programs requested by video subscribers of the video service provider, said method comprising the steps of:
receiving a first digital video file over the Internet at a web site hosted by said data processing system from said user, said digital video file representing said ad to be placed by said user;
storing said first digital video file in a memory of said data processing system;
using said first digital video file by said data processing system to generate an ad asset, said ad asset comprising a second digital video file and metadata wherein said second digital video file conforms to an encoding format compatible with an ad management system of said video service provider and said meta data reflects said encoding format, said second digital video file stored in said memory;
receiving at said data processing system from said user ad campaign data indicating attributes of an ad campaign, said ad campaign data comprising:
an indication that ad campaign is associated with one or more on-demand programs provided by said video service provider,
a starting date and ending date of said ad campaign,
an identifier of said ad asset associated with said ad campaign,
a value indicating an aggregate ad placement time,
a site location identifier indentifying a location of said video service provider comprising a video distribution network over which said ad is to be streamed; and
transmitting said ad asset and said ad campaign data over an interface of said data processing system to said video service provider capable of providing said one or more on-demand programs.

20. The method of claim 19 wherein said ad campaign data further comprising a rating indicator associated with said one or more on-demand programs.
